(19) United States
(12) Patent Application Publication
(10) Pub. No.: US 2025/0019560 A1
(43) Pub. Date: Jan. 16, 2025

(54) ACRYLIC MATERIALS AND USES THEREOF

(71) Applicant: PPG Industries Ohio, Inc., Cleveland, OH (US)

(72) Inventors: Yaqi Wo, Allison Park, PA (US); Qi Zheng, Wexford, PA (US); Edward Richard Millero, Jr., Gibsonia, PA (US); Yves Hamon, Harfleur (FR); David Robert Fenn, Allison Park, PA (US); Diane Lynne Wargo, Allison Park, PA (US); Alisa Celie Maier, Reutlingen (DE); Laudine Ducrocq, Rogerville (FR); Elzen Kurpejovic, Rangendingen (DE); John E. Schwendeman, Wexford, PA (US); Tanja Désirée Leitner, Tübingen (DE); Marco Fantin, Padova (IT)

(73) Assignee: PPG Industries Ohio, Inc., Cleveland, OH (US)

(21) Appl. No.: 18/711,728

(22) PCT Filed: Nov. 17, 2022
(86) PCT No.: PCT/US2022/080000

§ 371 Date: May 20, 2024

Related U.S. Application Data
(60) Provisional application No. 63/281,832, filed on Nov. 22, 2021.

(51) Int. Cl. C09D 133/06

(52) U.S. Cl. CPC C09D 133/066

(57) ABSTRACT

A package coated on at least a portion thereof with a coating, the coating bring derived from a solvent-borne coating composition, the solvent-borne coating composition comprising: a) an acrylic material having one or more terminal and/or side group(s) of Formula (I) wherein X represents an organic bridging group comprising at least 5 (five) carbon atoms; and Y represents an oxygen (O), nitrogen (N) or sulphur(S) atom: b) a crosslinker material operable to crosslink the hydroxyl functionality on the acrylic material; and c) a carrier comprising a solvent.

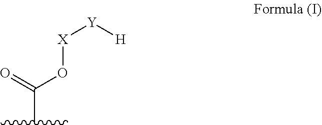

### FIELD OF INVENTION

The present invention relates to a package, such as a metal package, and in particular to a package coated on at least a portion thereof with a coating, the coating being derived from a solvent-borne coating composition comprising an acrylic material, a crosslinker material operable to crosslink the hydroxyl functionality on the acrylic material and a carrier comprising a solvent. The present invention extends to a food and/or beverage packaging, components used to fabricate such packaging and/or a monobloc aerosol can and/or tube, all of the aforesaid items being coated on at least a portion thereof with a coating, the coating being derived from a solvent-borne coating composition comprising an acrylic material, a crosslinker material operable to crosslink the hydroxyl functionality on the acrylic material and a carrier comprising a solvent.

### BACKGROUND OF THE INVENTION

The application of various treatment and pre-treatment solutions to metals to retard or inhibit corrosion is well established. This can be true in the area of food and/or beverage packaging, such as food and/or beverage cans, and/or monobloc aerosol cans and/or tubes. Coatings are applied to the interior of such containers to prevent the contents from contacting the metal of the container. Contact between the metal and the food and/or beverage can lead to corrosion of the metal container, which can then contaminate the food and/or beverage. This may be of concern when the contents of the can are acidic in nature, such as tomato-based products and soft drinks, for example. The coatings applied to the interior of food and/or beverage cans also help to prevent corrosion in the head space of the cans, which is the area between the fill line of the food product and the can lid.

Various epoxy-based coatings and polyvinyl chloride-based coatings have been used in the past to coat the interior of metal cans to prevent corrosion. The recycling of materials containing polyvinyl chloride or related halide-containing vinyl polymers can generate toxic by-products. Moreover, these polymers are typically formulated with epoxy-functional plasticizers. In addition, epoxy-based coatings are prepared from monomers such as bisphenol A and bisphenol A diglycidylether (“BADGE”). BPA is perceived as being harmful to human health and it is therefore desirable to eliminate it from coatings. Derivatives of BPA such as diglycidyl ethers of bisphenol A (BADGE), epoxy novolak resins and polyols prepared from BPA and bisphenol F (BPF) are also perceived to be problematic. Government authorities, particularly in Europe, are becoming even more restrictive on the amount of free BADGE or its by-products that are acceptable.

### SUMMARY OF THE INVENTION

According to the present invention there is provided a package coated on at least a portion thereof with a coating, the coating being derived from a solvent-borne coating composition, the solvent-borne coating composition comprising:
a) an acrylic material having one or more terminal and/or side group(s) of Formula (I)

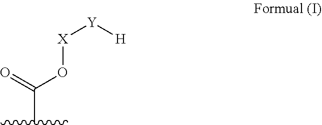

wherein X represents an organic bridging group comprising at least 5 (five) carbon atoms; Y represents an oxygen (O), nitrogen (N) or sulphur(S) atom;
b) a crosslinker material operable to crosslink the hydroxyl, amine and/or thiol functionality on the acrylic material; and
c) a carrier comprising a solvent.

There is also provided a metal package coated on at least a portion thereof with a coating, the coating being derived from a solvent-borne coating composition, the solvent-borne coating composition comprising:
a) an acrylic material having one or more terminal and/or side group(s) of Formula (I)

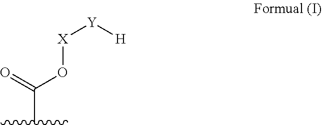

wherein X represents an organic bridging group comprising at least 5 (five) carbon atoms; Y represents an oxygen (O), nitrogen (N) or sulphur(S) atom;
b) a crosslinker material operable to crosslink the hydroxyl, amine and/or thiol functionality on the acrylic material; and
c) a carrier comprising a solvent.

There is also provided a food and/or beverage packaging and/or a monobloc aerosol can and/or tube coated on at least a portion thereof with a coating, the coating being derived from a solvent-borne coating composition, the solvent-borne coating composition comprising:
a) an acrylic material having one or more terminal and/or side group(s) of Formula (I)

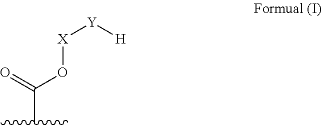

wherein X represents an organic bridging group comprising at least 5 (five) carbon atoms; Y represents an oxygen (O), nitrogen (N) or sulphur(S) atom;
b) a crosslinker material operable to crosslink the hydroxyl, amine and/or thiol functionality on the acrylic material; and
c) a carrier comprising a solvent.

There is also provided a package coated on at least a portion thereof with a coating, the coating being derived from a coating composition, the coating composition comprising:
a) an acrylic material having one or more terminal and/or side group(s) of Formula (I)

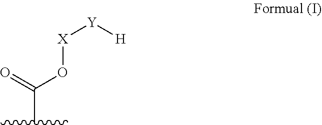

wherein X represents an organic bridging group comprising at least 5 (five) carbon atoms; Y represents an oxygen (O), nitrogen (N) or sulphur(S) atom; and
b) a crosslinker material operable to crosslink the hydroxyl, amine and/or thiol functionality on the acrylic material.

There is also provided a package coated on at least a portion thereof with a coating, the coating being derived from a coating composition, the coating composition comprising:
a) an acrylic material having one or more terminal and/or side group(s) of Formula (Ia)

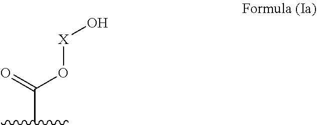

wherein X represents an organic bridging group comprising at least 6 (six) carbon atoms; and
b) a crosslinker material operable to crosslink the hydroxyl functionality on the acrylic material,
   wherein the terminal and/or side group(s) of Formula (Ia) is derived from a reaction between a hydroxyl, carboxylic acid, amine and/or thiol group and a lactone and/or lactide; and wherein the terminal and/or side group(s) comprise an average of at least 1.5 (n≥1.5) continuous lactone and/or lactide units in a poly(lactone) and/or poly(lactide) chain.

### DETAILED DESCRIPTION OF THE INVENTION

The coating composition comprises an acrylic material. The acrylic material may be any suitable acrylic material, with the proviso that it comprises at least one terminal and/or side group(s) of Formula (I) and/or (Ia).

The acrylic material may comprise the reaction product of a reaction mixture comprising one or more acrylic monomer(s). Suitable acrylic monomers will be known to a person skilled in the art. Suitable acrylic monomers include, but are not limited to, alkyl (alk)acrylate, such as C₁ to C₆ alkyl (C₁ to C₆ alk)acrylate, for example, C₁ to C₆ alkyl (meth)acrylate, and (alk)acrylic acid, such as (C₁ to C₆ alk)acrylic acid. The acrylic monomers may comprise a functional group, such as an epoxy group. For example, the acrylic monomers may comprise glycidyl methacrylate.

The terms “(alk)acrylate”, “(meth)acrylate”, and like terms as used herein, are used conventionally and herein to refer to both alkacrylate and acrylate, such as methacrylate and acrylate.

Examples of suitable acrylic monomers include, but are not limited to, acrylic acid, methacrylic acid, methyl acrylate; methyl methacrylate; ethyl acrylate; ethyl methacrylate; propyl acrylate; propyl methacrylate; isopropyl methacrylate, isobutyl methacrylate, n-butyl acrylate, such as, for example, t-butyl acrylate; n-butyl methacrylate, such as, for example, t-butyl methacrylate, pentyl acrylate, pentyl methacrylate, isoamyl acrylate, isoamyl methacrylate, hexyl acrylate, hexyl methacrylate, cyclohexyl acrylate, cyclohexyl methacrylate, decyl acrylate, decyl methacrylate, isodecyl acrylate, isodecyl methacrylate, lauryl acrylate, lauryl methacrylate, octyl acrylate, octyl methacrylate, nonyl acrylate, nonyl methacrylate, isobornyl acrylate, isobornyl methacrylate, hydroxyethyl acrylate, hydroxyethyl methacrylate, hydroxypropyl methacrylate, hydroxypropyl acrylate, phenoxy ethyl acrylate, 2-ethylhexyl acrylate, 2-ethylhexyl methacrylate, glycidyl methacrylate; the reaction product of (meth)acrylic acid reacted with an epoxy, such as the reaction product of (meth)acrylic acid reacted with Cardura (RTM) E10P glycidyl ester; ethylene glycol diacrylate; ethylene glycol dimethacrylate; 1,6-hexanediol diacrylate; 1,6-hexanediol dimethacrylate; 4-hydroxybutyl acrylate; 4-hydroxybutyl methacrylate; allyl methacrylate; benzyl acrylate; benzyl methacrylate; phosphate esters of 2-hydroxyethyl methacrylate; those sold under the trade name SIPOMER commercially available from Solvay) such as, for example SIPOMER PAM-100, SIPOMER PAM-200 and SIPOMER PAM-300 (phosphate esters of polypropylene glycol monoacrylate); and SIPOMER WAM, SIMPOMER WAM II and SIPOMER WAM E W50 (methacrylic monomer based on 46-50% methacrylamidoethyl ethylene urea), ureido (meth)acrylate (commercially available from BASF), rosin (meth)acrylate, cardanyl (meth)acrylate, cardanol (meth)acrylate, acrylamides such as, for example, acrylamide methacrylamide, N,N-dimethylacrylamide, N-ethylacrylamide, N-hydroxyethyl acrylamide, diacetone acrylamide, N,N-diethylacrylamide, N-isopropylacrylamide and N-isopropylmethacrylamide; 2-acrylamido-2-methyl-1-propanesulfonic acid; silane-functional (alk)acrylic acids and/or (alk)acrylates such as, for example, 3-(trimethoxysilyl) propyl methacrylate (also known as silane A174, commercially available from Sigma Aldrich) and 3-(trimethoxysilyl) propyl acrylate (commercially available from Sigma Aldrich); and combinations thereof. Any other acrylic monomers known to those skilled in the art could also be used.

The acrylic monomer may comprise a hydroxyl functional acrylic monomer. The acrylic monomer may comprise a hydroxyl functional alkyl (alk)acrylate, for example, hydroxyl functional C₁ to C₆ alkyl (C₁ to C₆ alk)acrylate, such as hydroxyl functional C₁ to C₆ alkyl (meth)acrylate or hydroxyl functional C₁ to C₆ alkyl (C₁ to C₆ alk)acrylate. Examples of suitable hydroxyl functional acrylic monomer(s) include, but are not limited to, hydroxyethyl acrylate, hydroxyethyl methacrylate, hydroxymethyl acrylate, hydroxymethyl methacrylate, hydroxypropyl acrylate, hydroxypropyl methacrylate, hydroxybutyl acrylate, hydroxybutyl methacrylate, hydroxypentyl acrylate, hydroxypentyl methacrylate, hydroxyhexyl acrylate, hydroxyhexyl methacrylate, methyl 2-(hydroxymethyl)acrylate ethyl 2-(hydroxymethyl)acrylate, polyethylene glycol methacrylate and/or polypropylene glycol methacrylate. The hydroxyl functional acrylic monomer may comprise hydroxyethyl acrylate, hydroxyethyl methacrylate, the reaction product of (meth)acrylic acid reacted with an epoxy, such as the reaction product of (meth)acrylic acid with Cardura (RTM) E10P glycidyl ester, polyethylene glycol methacrylate and/or polypropylene glycol methacrylate.

The acrylic monomer may comprise two or more acrylate groups. For example, the acrylic monomer may comprise two, three, four or more acrylate groups. For the avoidance of doubt, by “acrylate group”, and like terms as used herein, is meant salts and esters of acrylic acid, i.e. monomers having the structure R—C═CCOO—R¹, wherein R represents hydrogen, alkyl, alkenyl alkynyl, aralkyl or aryl and R¹ represents hydrogen, alkyl, alkenyl alkynyl, aralkyl or aryl. The acrylic monomer may comprise a di(alk)acrylate. Suitable di(alk)acrylates will be known to a person skilled in the art. Examples of suitable di(alk)acrylates include, but are not limited to, ethylene glycol diacrylate, ethylene glycol dimethacrylate, 1,2-propanediol diacrylate, 1,3-propanediol diacrylate, 1,3-butanediol diacrylate, 1,4-butanediol diacrylate, 1,2-petanediol diacrylate, 1,3-petanediol diacrylate, 1,5-petanediol diacrylate, 1,2-hexanediol diacrylate, 1,3-hexanediol diacrylate, 1,4-hexanediol diacrylate, 1,6-hexanediol diacrylate, 1,2-propanediol dimethacrylate, 1,3-propanediol dimethacrylate, 1,3-butanediol dimethacrylate, 1,4-butanediol dimethacrylate, 1,2-petanediol dimethacrylate, 1,3-petanediol dimethacrylate, 1,5-petanediol dimethacrylate, 1,2-hexanediol dimethacrylate, 1,3-hexanediol dimethacrylate, 1,4-hexanediol dimethacrylate, 1,6-hexanediol dimethacrylate and combinations thereof. The acrylic monomer may comprise a tri(alk)acrylate. Suitable tri(alk)acrylates will be known to a person skilled in the art. Examples of suitable tri(alk)acrylates include, but are not limited to, trimethylolpropane triacrylate, trimethylolpropane trimethacrylate and combinations thereof.

The acrylic monomer may comprise a di(alk)acrylate and/or tri(alk)acrylate.

The acrylic monomer may comprise a diacrylate and/or a dimethacrylate.

The acrylic monomer may comprise hexanediol diacrylate, such as 1,6-hexanediol diacrylate, and/or ethylene glycol dimethacrylate.

The acrylic monomer may comprise a di(meth)acrylate, such as a diacrylate.

The acrylic monomer may comprise hexanediol diacrylate, such as 1,6-hexanediol diacrylate.

The reaction mixture from which the acrylic material is formed may comprise any suitable amount of di(alk)acrylate and/or tri(alk)acrylate. The acrylic material may, therefore, be formed from monomers comprising any suitable amount of di(alk)acrylate and/or tri(alk)acrylate. The acrylic material may comprise up to 5 wt %, such as up to 4 wt %, such as up to 3 wt %, such as up to 2 wt %, or even up to 1 wt % di(alk)acrylate and/or tri(alk)acrylate based on the total solid weight of the monomers from which the acrylic material is formed.

The use of one or more di(alk)acrylate, tri(alk)acrylate or higher (alk)acrylate may advantageously increase the molecular weight of the acrylic material, i.e. the di(alk)acrylate, tri(alk)acrylate or higher (alk)acrylate may be used to build the molecular weight of the acrylic material. The use of one or more di(alk)acrylate, tri(alk)acrylate or higher (alk)acrylate may advantageously increase the degree of branching of the acrylic material.

The reaction mixture from which the acrylic material is formed may comprise a silane-functional acrylic monomer, such as a silane-functional (alk)acrylic acid and/or (alk)acrylate. The acrylic material may therefore comprise a silane-functional acrylic monomer, such as a silane-functional (alk)acrylic acid and/or (alk)acrylate. The use of one or more silane-functional acrylic monomer(s) may advantageously improve the adhesion of the coating compositions.

The reaction mixture from which the acrylic material is formed may further comprise one or more additional ethylenically unsaturated monomer(s). Suitable additional ethylenically unsaturated monomers will be known to a person skilled in the art. Examples of suitable additional ethylenically unsaturated monomers include, but are not limited to, aryl substituted ethylenically unsaturated monomers such as, for example, styrene, alpha-methyl styrene, 3,4-alpha-methyl styrene, 2-methyl styrene, 4-methyl styrene (vinyl toluene), 2,3-dimethyl styrene, 2-ethyl styrene, 4-tertbutylstyrene, 4-methoxystyrene, 4-phenylstyrene, 4-phenoxy styrene, 4-propyl styrene, 4-benzylstyrene, 4-cyclohexyl styrene, 4-dodecyl styrene, 4-(phenyl butyl) styrene, 2-methyl-4-isopopyl styrene, 2-ethyl-4-benzyl styrene, 4-chlorostyrene, 2,5-dichlorostyrene, 3,4-dichlorostyrene, 2,6-dichlorostyrene, 4-fluorostyrene, divinylbenzene, isopropyl t-butyl styrene, styrene, trans-beta-styrene, chloromethylstyrene, 4-hydroxystyrene, diglycidyloxymethylstyrene, 2,4-diglycidyloxymethylstyrene, 2,5-diglycidyloxymethylstyrene, 2,6-diglycidyloxymethylstyrene, 2,3,4-triglycidyloxymethylstyrene, 2,3,5-triglycidyl oxime styrene, 2,3,6-triglycidyloxymethylstyrene and 3,4,5-triglycidyloxymethylstyrene, 2,4,6-triglycidyloxymethylstyrene, unsaturated carboxylic acids or diacids (or anhydrides) such as, for examples, maleic acid (or anhydride) and itaconic acid (or anhydride), ethylenically unsaturated nitriles such as, for example, acrylonitrile or methacrylonitrile, vinyl esters such as, for example, vinyl acetate and vinyl propionate, alkenes, such as C₂ to C₆ alkenes, for example, ethene, propene, 1-butene, 2-butene, 1-pentene, 2-pentene, 1-hexene, 2-hexene, 3-hexene, 1-hetpene, 2-heptene, 3-heptene, 1-octene, 2-octene, 3-octene, 4-octene and isobutylene, vinyl chloride, butadiene, isoprene, chloroprene, N-vinyl monomers such as, for example, N-vinyl pyrrolidone, N-vinyl caprolactam and N-vinyl acetamide, unsaturated fatty acid ester; allyl glycidyl ether, allyl ethyl ether, vinyl ether monomers such as, for example, methyl vinyl ether, ethyl vinyl ether, n-propyl vinyl ether, isopropyl vinyl ether, n-butyl vinyl ether, isobutyl vinyl ether, t-butyl vinyl ether, pentyl vinyl ether, cyclopentyl vinyl ether, hexyl vinyl ether, cyclohexyl vinyl ether, 2-ethylhexyl vinyl ether, 2-hydroxyethyl vinyl ether, 4-hydroxybutyl vinyl ether, 1,4-butanediol divinyl ether, diethyleneglycol divinyl ether, triethyleneglycol divinyl ether, 1,4-cyclohexanedimethanol divinyl ether, 2-(2-hydroxyethyl) ethyl vinyl ether, octyl vinyl ether, benzyl vinyl ether, phenyl vinyl ether, phenethyl vinyl ether and allyl vinyl ether, vinylphosphoric acid (commercially available from Sigma Aldrich) and combinations thereof. The additional ethylenically unsaturated monomer(s) may comprise monomers, oligomers and/or polymers of the aforementioned monomers. For example, butadiene may be in the form of a monomer or may be in the form of polybutadiene.

The additional ethylenically unsaturated monomer(s) may comprise terpene monomers or derivatives thereof, rosin monomers or derivatives thereof, cardanol monomers or derivatives thereof.

Examples of suitable terpene monomers or derivatives thereof include, but are not limited to, monoterpenes such as, for example, a-pinene, B-pinene, camphene, sabinene, limonene and myrcene, sesquiterpenes such as, for example, bisabolene and nerolidol, and diterpenes. Examples of suitable rosin monomers or derivates thereof include, but are not limited to, rosin, rosin acids, abietic acid, neabietic acid, palustric acid, pimaric acid, levopimaric acid, maleopimaric acid, fumaropimaric acid, isopimaric acid, rosin-formaldehyde resin, rosin alcohol and rosin phenol. Examples of suitable cardanol monomers or derivatives thereof of include, but are not limited to cardanol, anacardic acid, cardanol glycidyl ether, cardanol-formaldehyde resin, cardanol epoxies, cardanol phenols and cardanol alcohols.

The additional ethylenically unsaturated monomer may comprise a hydroxyl functional ethylenically unsaturated monomer. The hydroxyl functional ethylenically unsaturated monomer may comprise N-hydroxyethyl acrylamide, 2-hydroxyethyl vinyl ether, 4-hydroxybutyl vinyl ether, 2-(2-hydroxyethyl) ethyl vinyl ether, and/or hydroxystyrene. The hydroxyl functional ethylenically unsaturated monomer may comprise the reaction product of (meth)acrylic acid with an epoxy (such as Cardura E10) and/or the reaction product of glycidyl methacrylate with a carboxylic acid functional component (such as a benzoic acid and/or an aliphatic acid, such as a C₂-C₂₀ aliphatic acid, for example).

The reaction mixture from which the acrylic material is formed may comprise an acid-functional acrylic monomer and/or additional ethylenically unsaturated monomer. The acrylic material may therefore comprise an acid-functional acrylic monomer and/or additional ethylenically unsaturated monomer. Examples of suitable acid-functional monomers include, but are not limited to, those sold under the tradename Sipomer (RTM), such as Sipomer PAM and Sipomer WAM commercially available from Solvay; vinyl phosphoric acid; (alk)acrylic acids, such as methacrylic acid; and combinations thereof. The use of one or more acid-functional acrylic and/or additional ethylenically unsaturated monomer(s) may advantageously improve the adhesion of the coating compositions.

The reaction mixture from which the acrylic material is formed may comprise an ureido-functional acrylic monomer and/or additional ethylenically unsaturated monomer, such as ureido (alk)acrylate, or even ureido methacrylate. The acrylic material may therefore comprise an ureido-functional acrylic monomer and/or additional ethylenically unsaturated monomer, such as ureido (alk)acrylate, or even ureido methacrylate. The use of one or more ureido-functional acrylic and/or additional ethylenically unsaturated monomer(s) may advantageously improve the adhesion of the coating compositions.

The reaction mixture from which the acrylic material is formed may be substantially free, may be essentially free or may be completely free of styrene. It will be appreciated, therefore, that the acrylic material may be substantially free, may be essentially free or may be completely free of styrene. By “substantially” free in relation to styrene, is meant that the acrylic material is formed from monomers which comprise less than 5 wt % of styrene based on the total weight of the monomers from which the acrylic material is formed. By “essentially free” in relation to styrene, is meant that the acrylic material is formed from monomers which comprise less than 1 wt % of styrene based on the total weight of the monomers from which the acrylic material is formed. By “completely free” in relation to styrene, is meant that the acrylic material is formed from monomers which comprise less than 0.01 wt % of styrene based on the total weight of the monomers from which the acrylic material is formed.

The reaction mixture from which the acrylic material is formed may comprise no, i.e. 0 wt %, styrene based on the total solid weight of the monomers. The acrylic material, therefore, may be formed from monomers which comprise no, i.e. 0 wt %, styrene based on the total weight of the monomers from which the acrylic material is formed.

Advantageously, the acrylic material may be completely free of styrene.

The acrylic material may comprise any suitable amount of acrylic monomer. It will be appreciated that the acrylic material suitably comprises at least one acrylic monomer.

The acrylic material may comprise at least 10 wt %, such as at least 20 wt %, such as at least 30 wt %, such as at least 40 wt %, such as at least 50 wt %, such as at least 60 wt %, such as at least 70 wt %, such as at least 75 wt % acrylic monomer, such as at least 80 wt %, such as at least 85 wt %, such as at least 90 wt %, such as at least 95 wt %, such as at least 97 wt %, such as at least 98 wt %, such as at least 99 wt %, or even >99 wt %, for example, at least 99.1 wt %, at least 99.5 wt % or at least 99.9 wt % acrylic monomer based on the total solid weight of the monomers from which the acrylic material is formed. The acrylic material may comprise 100 wt % acrylic monomer based on the total solid weight of the monomers from which the acrylic material is formed.

The reaction mixture from which the acrylic material is formed may comprise styrene, isobornyl acrylate, isobornyl methacrylate, cyclohexyl methacrylate, 2-ethylhexyl acrylate, 2-ethylhexyl methacrylate, 2-hydroxyethyl acrylate, 2-hydroxyethyl methacrylate, 4-hydroxybutyl acrylate, methyl methacrylate, n-butyl acrylate, n-butyl methacrylate such as, for example, t-butyl methacrylate, ethyl methacrylate, hydroxypropyl acrylate, hydroxypropyl methacrylate, methacrylic acid, acrylic acid and combinations thereof.

The reaction mixture from which the acrylic material is formed may comprise isobornyl acrylate, isobornyl methacrylate, cyclohexyl methacrylate, 2-ethylhexyl acrylate, 2-ethylhexyl methacrylate, 2-hydroxyethyl acrylate, 2-hydroxyethyl methacrylate, 4-hydroxybutyl acrylate, methyl methacrylate, n-butyl acrylate, n-butyl methacrylate such as, for example, t-butyl methacrylate, ethyl methacrylate, hydroxypropyl acrylate, hydroxypropyl methacrylate, methacrylic acid, acrylic acid and combinations thereof.

The acrylic material may have one or more terminal and/or side group(s) of Formula (I)

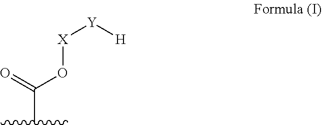

wherein X represents an organic bridging group comprising at least 5 (five) carbon atoms; Y represents an oxygen (O), nitrogen (N) or sulphur(S) atom.

X may be any suitable organic bridging group, with the proviso that. For the avoidance of doubt, by ‘comprising at least 5 (five) carbon atoms’ is meant the chain of atoms that directly connects the adjacent groups, O and Y, and not the total number of carbon atoms in the bridging group. For example, and by way of example only, X may be —CH₂—CH₂—CH₂—CH₂—CH₂— or —CH₂—C(CH₃)₂—CH₂—CH₂—CH₂—, wherein in each case 5 (five) carbon atoms directly connect the adjacent groups, O and Y. However, and by way of example only, —CH₂—C(CH₃)₂—CH₂— is not included within the definition of X as the bridge between the adjacent groups, O and Y, comprises only 3 carbon atoms.

X may be linear or branched.

X may be substituted or unsubstituted. X may be substituted by any suitable group. Examples of suitable groups include, but are not limited to, OR¹, OC(O)R², C(O)R³, C(O)OR⁴, NR⁵R⁶, C(O)NR⁷R⁸, aryl or Het, wherein R¹ to R⁸ each independently represents hydrogen, aryl or alkyl, such as hydrogen, C₆ to C₁₀ aryl or C₁ to C₁₀ alkyl, such as hydrogen, C₆ aryl or C₁ to C₄ alkyl. X may be substituted with one or more OR¹ group(s), wherein each R¹ represents hydrogen, aryl or alkyl, such as hydrogen or alkyl, such as hydrogen or C₁ to C₆ alkyl, such as hydrogen or C₁ to C₄ alkyl, such as hydrogen or C₁ to C₂ alkyl, such as hydrogen or methyl, such as hydrogen.

X may be substituted by a hydroxyl group. For the avoidance of doubt, when X is substituted by a hydroxyl group, the substituted hydroxyl group may be situated at any position on the bridging group, X. For example, X may comprise a hydroxyl group at a position wherein there are only 1, 2, 3, or 4 carbon atoms between the oxygen atom (—O—) of Formula (I) and the oxygen atom of the substituted hydroxyl group on the proviso that there is also at least 5 (five) carbon atoms between the adjacent groups, O and Y.

It will be appreciated that when X is substituted by a hydroxyl group and Y is an oxygen (O) atom, X may comprise one or more primary hydroxyl group(s) and one or more secondary hydroxyl group(s). The acrylic material may comprise any suitable amount of primary and secondary hydroxyl groups. For example, the acrylic material may comprise at least 10%, such as at least 20%, such as at least 30%, such as at least 40%, such as at least 50%, such as at least 60%, such as at least 70%, such as at least 80%, or even at least 90% primary hydroxyl groups based on the total number of hydroxyl groups present in the terminal and/or side group(s) of Formula (I). When Y is an oxygen (O) atom, the acrylic material may comprise 100% primary hydroxyl groups based on the total number of hydroxyl groups present in the terminal and/or side group(s) of Formula (I). For the avoidance of doubt, X may comprise one or more than one primary hydroxyl group(s). X may comprise one primary hydroxyl group.

X may be interrupted by one or more heteroatoms. For the avoidance of doubt, by ‘interrupted by one or more heteroatoms’ is meant that the chain of carbon atoms between the adjacent groups, O and Y, may further include one or more heteroatom(s) such that the bridging group, X, comprises both carbon atoms and one or more heteroatom(s). For example, X may comprise 5, or 6, 7, 8, 9, 10, 11, 12, 13, 14, 15, 16 etc. carbon atoms and one or more additional heteroatom(s) in the chain of atoms that directly connects the adjacent groups, O and Y. X may be substituted by any suitable heteroatom. For example, X may be substituted by an oxygen, sulphur and/or nitrogen atom. X may be substituted by an oxygen atom.

X may comprise a carbonyl group. For the avoidance of doubt, when X comprises a carbonyl group, the carbon atom of the carbonyl group should be included when determining the number of carbon atoms in the bridging group, X, when said carbon atom of the carbonyl group is part of the chain of atoms that directly connects the adjacent groups, O and Y.

X may be selected from the group consisting of —(CH₂)₂—[—O—C(═O)—(CH₂)₅]ₙ—, wherein n represents an integer from 1 to 5, —(CH₂)₂—O—C(═O)—(CH₂)₅—O—C(═O)—(CH₂)₅—, —CH₂—CH(OH)—CH₂—O—C(═O)—(CH₂)₁₀—CH(OH)—(CH₂)₆—, —CH₂—CH(OH)—CH₂—O—C(═O)—(CH₂)₁₇— and/or —(CH₂)₂—[—O—(CH₂)₂]₉—.

For the avoidance of doubt, when the acrylic material comprises more than one terminal and/or side group of Formula (I), X of each terminal and/or side group may be the same or different.

The bridging group, X, may comprise at least 6 carbon atoms, such as at least 7, 8, 9, 10, 11, 12, 13 or even 14 carbon atoms.

The bridging group, X, may comprise at least 6 (six) carbon atoms.

The bridging group, X, may comprise at least 8 (eight) carbon atoms.

The bridging group, X, may comprise at least 12 (twelve) carbon atoms.

The bridging group, X, may comprise at least 14 (fourteen) carbon atoms.

Y represents an oxygen (O), nitrogen (N) or sulphur(S) atom. It will be appreciated that when Y is an oxygen (O) atom, the acrylic material has hydroxyl functionality. Similarly, when Y is a nitrogen (N) atom, the acrylic material has amine functionality. Similarly, when Y is a sulphur(S) atom, the acrylic material has thiol functionality. Thus, the acrylic material may have hydroxyl, amine and/or thiol functionality.

Y may be an oxygen (O) or nitrogen (N) atom.

Y may be an oxygen (O) atom. It will be appreciated that when Y is an oxygen atom, the acrylic material will suitably be an acrylic polyol having one or more terminal and/or side group(s) of Formula

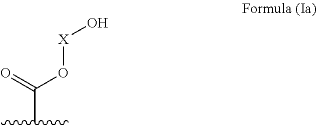

Thus, there is also provided a package coated on at least a portion thereof with a coating, the coating being derived from a solvent-borne coating composition, the solvent-borne coating composition comprising:
a) an acrylic material having one or more terminal and/or side group(s) of Formula (Ia)

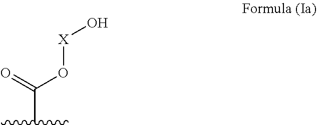

wherein X represents an organic bridging group comprising at least 5 (five) carbon atoms;
b) a crosslinker material operable to crosslink the hydroxyl functionality on the acrylic material; and
c) a carrier comprising a solvent.

X in relation to Formula (Ia) is as defined herein in relation to Formula (I). It will be appreciated by a person skilled in the art that reference to the “adjacent groups, O and Y” in relation to Formula (I) is equivalent to, and can be read as, “adjacent groups, O and —OH” in relation to Formula (Ia).

For the avoidance of doubt, when the acrylic material comprises more than one terminal and/or side group of Formula (I) and/or (la), Y of each terminal and/or side group may be the same or different. For the avoidance of doubt, when the acrylic material comprises more than one terminal and/or side group of Formula (Ia), X of each terminal and/or side group may be the same or different.

The terminal and/or side group(s) of Formula (I) and/or (Ia) may be derived from the reaction between a hydroxyl, carboxylic acid, oxirane, amine and/or thiol group and a cyclic ester, hydroxy acid, ester of a hydroxy acid and/or cyclic amide. It will be appreciated by a person skilled in the art that the hydroxyl, carboxylic acid, oxirane, amine and/or thiol group may suitably react with one or more of the cyclic ester, hydroxy acid, ester of a hydroxy acid and/or cyclic amide as appropriate. For example, it will be known to a person skilled in the art that an oxirane group, for example, may react with a hydroxy acid and/or ester of a hydroxy acid and not with a cyclic ester. It will also be known to a person skilled in the art that for Formula (Ia) the reaction is suitably between a hydroxyl, carboxylic acid, oxirane, amine and/or thiol group and a cyclic ester, hydroxy acid and/or ester of a hydroxy acid (and not a cyclic amide).

The terminal and/or side group(s) of Formula (I) and/or (Ia) may be derived from the reaction between a hydroxyl, carboxylic acid, amine and/or thiol group and a cyclic ester and/or cyclic amide, such as between a hydroxyl and/or carboxylic acid group and a cyclic ester and/or cyclic amide, or even between a hydroxyl group and a cyclic ester and/or cyclic amide.

The terminal and/or side group(s) of Formula (I) and/or (Ia) may be derived from the reaction between a hydroxyl, carboxylic acid, amine and/or thiol group and a cyclic ester, such as between a hydroxyl and/or carboxylic acid group and a cyclic ester, or even between a hydroxyl group and a cyclic ester.

The terminal and/or side group(s) of Formula (I) and/or (Ia) may be derived from the reaction between an oxirane group and a hydroxy acid and/or ester of a hydroxy acid, such as between an oxirane group and a hydroxy acid.

The terminal and/or side group(s) of Formula (I) and/or (Ia) may be derived from the reaction between an oxirane group and a hydroxy acid and/or ester of a hydroxy acid, such as between an oxirane group and a hydroxy acid.

The cyclic ester may comprise any suitable cyclic ester. Examples of suitable cyclic esters include, but are not limited to, lactones such as, for example, α-acetolactone, β-propiolactone, γ-butyrolactone, δ-valerolactone, caprolactone and substituted caprolactones such as, for example, trimethylcaprolactone, 4-methyl-ε-caprolactone and 6-methyl-ε-caprolactone, lactides such as, for example, (R,R)-lactide, (S,S)-lactide and meso-lactide and combinations thereof.

The cyclic ester may comprise a lactone, such as caprolactone and/or trimethylcaprolactone, or even caprolactone.

The hydroxy acid may be any suitable hydroxy acid. Examples of suitable hydroxy acids include, but are not limited to, hydroxy fatty acids. Examples of suitable hydroxy fatty acids include, but are not limited to hydroxy caprylic acid, hydroxy capric acid, hydroxy lauric acid, hydroxy myristic acid, hydroxy palmitic acid, hydroxy stearic acid such as, for example, 12-hydroxy stearic acid and combinations thereof. The hydroxy acid may comprise hydroxy stearic acid, such as 12-hydroxy stearic acid.

The ester of a hydroxy acid may be any suitable ester of a hydroxy acid. Examples of suitable ester of a hydroxy acid include, but are not limited to, esters of the hydroxy fatty acids as defined herein.

The cyclic amide may be any suitable cyclic amide. Examples of suitable cyclic amides include, but are not limited to, lactams, such as, for example, β-propiolactam, γ-butyrolactam, δ-valerolactam, and ε-caprolactam; substituted caprolactams; and combinations thereof.

The hydroxyl, carboxylic acid, oxirane, amine and/or thiol groups may be reacted with a cyclic ester, hydroxy acid, ester of a hydroxy acid and/or cyclic amide at any suitable time. The hydroxyl, carboxylic acid, oxirane, amine and/or thiol groups may be reacted with a cyclic ester, hydroxy acid, ester of a hydroxy acid and/or cyclic amide before or after polymerisation.

For example, the cyclic ester, hydroxy acid, ester of a hydroxy acid and/or cyclic amide may be reacted with an acrylic pre-polymer having one or more hydroxyl, carboxyl, oxirane, amine and/or thiol group(s) to form the acrylic materials of the present invention. Thus, the acrylic material of the present invention may be formed by a method comprising reacting an acrylic pre-polymer having one or more hydroxyl, carboxylic acid, oxirane, amine and/or thiol group(s) with a cyclic ester, hydroxy acid, ester of a hydroxy acid and/or cyclic amide.

Thus, there is also provided a method of forming an acrylic material comprising reacting an acrylic pre-polymer having one or more hydroxyl, carboxylic acid, oxirane, amine and/or thiol group(s) with a cyclic ester, hydroxy acid, ester of a hydroxy acid and/or cyclic amide.

The acrylic material of the present invention may be formed by a method comprising reacting an acrylic pre-polymer having one or more hydroxyl group(s) with a cyclic ester and/or cyclic amide. The acrylic material of the present invention may be formed by a method comprising reacting an acrylic pre-polymer having one or more hydroxyl group(s) with a cyclic ester, such as a lactone and/or lactide, or even a lactone.

The acrylic material of the present invention may be formed by a method comprising reacting an acrylic pre-polymer having one or more oxirane group(s) with a hydroxy acid, such as hydroxy stearic acid, or even 12-hydroxy stearic acid.

When the acrylic material is formed from a method comprising reacting an acrylic pre-polymer having one or more hydroxyl, carboxylic acid, oxirane, amine and/or thiol group(s) with a cyclic ester, hydroxy acid, ester of a hydroxy acid and/or cyclic amide, the step of reacting the acrylic pre-polymer with a cyclic ester, hydroxy acid, ester of a hydroxy acid and/or cyclic amide may be carried out in the presence of a catalyst. The catalyst may be any suitable catalyst. Suitable catalysts include, but are not limited to, tin containing catalysts, such as tin 2-ethylhexanoate, monobutyl tin tris (2-ethylhexanoate), tin chloride, tin acetate, tin oxalate, zinc containing catalysts such as zinc neodecanoate, zinc stearate, zinc acetate dihydrate, zinc acetate anhydrous, zirconium containing catalysts, such as those sold under the tradename KKAT (RTM), for example KKAT 4205, KKAT XK 4006 and KKAT XK-682 (commercially available from King Industries), titanate based catalysts, such as tetrabutyl titanate TnBT (commercially available from Sigma Aldrich) and titanium butoxide, acid-based catalysts such as p-toluenesulphonic acid, those sold under the tradename Nacure (RTM) such as Nacure 5076, Nacure 296B and Nacure 115 commercially available from King Industries, Inc., alkyl benzene sulphonic acid and phosphoric acid; and combinations thereof.

The catalyst may comprise tin 2-ethylhexanoate.

The catalyst may comprise a zinc containing catalyst, a zirconium containing catalyst and/or an acid-based catalyst, such as a zinc containing catalyst and/or an acid-based catalyst, such as a zinc containing catalyst, such as an acid-based catalyst.

The catalyst may be used in any suitable amount. The catalyst may be used in an amount from 0.01 to 2 wt %, such as from 0.05 to 1 wt %, such as from 0.1 to 0.7 wt %, or even from 0.1 to 0.5 wt % catalyst based on the total solid weight of monomer solids.

The step of reacting the acrylic pre-polymer with a cyclic ester, hydroxy acid, ester of a hydroxy acid and/or cyclic amide may be carried out in the absence of a catalyst. For example, the step of reacting the acrylic pre-polymer with a cyclic ester, hydroxy acid, ester of a hydroxy acid and/or cyclic amide may be carried out in a reaction mixture which is substantially free, may be essentially free or may be completely free of catalyst. By “substantially free” we mean to refer to reaction mixtures containing less than 1000 parts per million (ppm) of catalyst. By “essentially free” we mean to refer to reaction mixtures containing less than 100 ppm of catalyst. By “completely free” we mean to refer to reaction mixtures containing less than 20 parts per billion (ppb) of catalyst. The reaction mixture may comprise 0 wt % of catalyst. Advantageously, the absence of a catalyst in the step of reacting the acrylic pre-polymer with a cyclic ester, hydroxy acid, ester of a hydroxy acid and/or cyclic amide means that the resultant coating compositions may be more suitable for food contact applications.

When the acrylic material is formed from a method comprising reacting an acrylic pre-polymer having one or more hydroxyl, carboxylic acid, oxirane, amine and/or thiol group(s) with a cyclic ester, hydroxy acid, ester of a hydroxy acid and/or cyclic amide, the step of reacting the acrylic pre-polymer with a cyclic ester, hydroxy acid, ester of a hydroxy acid and/or cyclic amide may be carried out at any suitable temperature. For example, the reaction may be carried out at a temperature from 100 to 200° C., such as from 120 to 180° C., such as from 135 to 165° C., or even from 140 to 160° C.

When the acrylic material is formed from a method comprising reacting an acrylic pre-polymer having one or more hydroxyl, carboxylic acid, oxirane, amine and/or thiol group(s) with a cyclic ester, hydroxy acid, ester of a hydroxy acid and/or cyclic amide, the step of reacting the acrylic pre-polymer with a cyclic ester, hydroxy acid, ester of a hydroxy acid and/or cyclic amide may be carried out for any suitable amount of time, T. For example, the reaction may be carried out for a time, T, of at least 30 minutes, such as at least 2 hours, such as at least 3 hours, such as at least 4 hours, or even at least 5 hours.

As described above, X may be interrupted by one or more heteroatoms. It will be appreciated by a person skilled in the art that when the acrylic material is formed from a method comprising reacting a hydroxyl, carboxylic acid, oxirane, amine and/or thiol group(s) with a cyclic ester, hydroxy acid, ester of a hydroxy acid and/or cyclic amide, the oxygen, nitrogen and/or sulphur atom(s) of the aforementioned hydroxyl, carboxylic acid, oxirane, amine and/or thiol group(s) may suitably be those that interrupt the bridging group, X. For example, in the exemplary case where an acrylic pre-polymer is formed, if said acrylic pre-polymer is formed from a hydroxyethyl (alk)acrylate monomer, the oxygen atom of the hydroxyethyl group suitably interrupts the bridging group, X, after reaction with a cyclic ester, for example. For example, if said acrylic pre-polymer is formed from an aminoethyl (alk)acrylate monomer, the nitrogen atom of the aminoethyl group suitably interrupts the bridging group, X, after reaction with a cyclic ester, for example. It will also be appreciated that the carbonyl group of the cyclic ester, for example, also suitably interrupts the bridging group, X, in each of these exemplary cases.

Additionally and/or alternatively, the terminal and/or side group(s) may be derived from one or more monomer(s) of Formula (II)

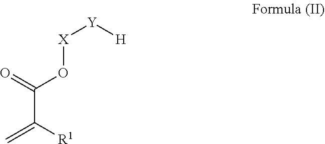

wherein X is as defined herein; Y is as defined herein; and R¹ represents hydrogen, alkyl, alkenyl alkynyl, aralkyl or aryl, such as hydrogen or alkyl, such as hydrogen or C₁-C₁₀ alkyl, such as hydrogen or C₁-C₆ alkyl, such as hydrogen or C₁-C₈ alkyl, or even hydrogen or methyl. It will be appreciated that when the terminal and/or side group(s) may be derived from one or more monomers of Formula (II), the reaction mixture from which the acrylic material is formed suitably comprises one or more monomer(s) of Formula (II).

The monomers of Formula (II) may be derived from the reaction between an acrylic monomer having a hydroxyl, carboxylic acid oxirane, amine and/or thiol group and a cyclic ester, hydroxy acid ester of a hydroxy acid and/or cyclic amide. Examples of suitable cyclic esters, hydroxy acids, esters of a hydroxy acid and/or cyclic amides are as defined herein. Examples of suitable monomers having a hydroxyl, carboxylic acid, oxirane, amine and/or thiol group include, but are not limited to, acrylic acid, methacrylic acid, hydroxyethyl methacrylic acid, hydroxybutyl acrylate, hydroxylpropyl acrylate, hydroxypropyl methacrylate, maleic acid, maleic anhydride, itaconic acid, itaconic anhydride, glycidyl methacrylate, hydroxyethyl acrylate and combinations thereof.

The monomers of Formula (II) may be derived from the reaction between glycidyl methacrylate and a hydroxy fatty acid, such as 12-hydroxy stearic acid.

The monomers of Formula (II) may be commercially available. The monomers of Formula (II) may be any suitable commercially available monomer. Examples of suitable commercially available monomers of Formula (II) include, but are not limited to, those sold under the Tone (RTM) tradename such as, for example, Tone M-201 and Tone M-100 commercially available from Dow Chemical, those sold under the tradename Placcel (RTM) F such as, for example, Placcel FM1, FM1D, FM2D, FM3, FM3X, FM4, FM5, FA1, FA1DDM, FA2D, FA5 and FA10L commercially available from Daicel Corporation, polyethoxy (10) ethyl methacrylate (HEMA-10) commercially available from Sigma Aldrich, polypropylene glycol methacrylate commercially available from Sigma Aldrich and combinations thereof.

When the terminal and/or side group(s) of Formula (I) and/or (Ia) are derived from the reaction between a hydroxyl, carboxylic acid, amine and/or thiol group and a lactone and/or lactide, it will be appreciated that one or more units of said lactone and/or lactide may be caused to react to form, in the latter case, a continuous poly(lactone) and/or poly(lactide) chain.

For example, the terminal and/or side group(s) may comprise an average of at least 1.5 (n≥1.5) continuous lactone and/or lactide units in a poly(lactone) and/or poly(lactide) chain, such as more than 1.5 (n≥1.5) continuous lactone and/or lactide units in a poly(lactone) and/or poly(lactide) chain, or even at least 2 (n≥2) continuous lactone and/or lactide units in a poly(lactone) and/or poly(lactide) chain. The terminal and/or side group(s) may comprise an average of up to 8 (n$8), such as up to 7 (n≤7), such as up to 6 (n$6), such as up to 5 (n≤5), or even up to 4 (n≤4) continuous lactone and/or lactide units in a poly(lactone) and/or poly(lactide) chain. The terminal and/or side group(s) may comprise an average from 1.5 to 8, such as from 1.5 to 7, such as from 1.5 to 6, such as from 1.5 to 5, or even from 1.5 to 4 continuous lactone and/or lactide units in a poly(lactone) and/or poly(lactide) chain. The terminal and/or side group(s) may comprise an average of more than 1.5 and up to 8, such as more than 1.5 and up to 7, such as more than 1.5 and up to 6, such as more than 1.5 and up to 5, or even more than 1.5 and up to 4 continuous lactone and/or lactide units in a poly(lactone) and/or poly(lactide) chain. The terminal and/or side group(s) may comprise an average from 2 to 8, such as from 2 to 7, such as from 2 to 6, such as from 2 to 5, or even from 2 to 4 continuous lactone and/or lactide units in a poly(lactone) and/or poly(lactide) chain.

The average number of lactone and/or lactide units in the poly(lactone) and/or poly(lactide) chains may suitably be calculated from the ratio of the number of moles of lactone and/or lactide to the number of moles of hydroxyl and/or carboxylic acid groups. All values for the average number of lactone and/or lactide units in the poly(lactone) and/or poly(lactide) chains reported herein were calculated this way unless specified otherwise.

The acrylic material may be formed by any suitable method. Suitable methods will be known to a person skilled in the art. For example, the acrylic material made be formed by a solution, emulsion and/or suspension polymerisation method. It will be appreciated that when the acrylic material is formed by reacting an acrylic pre-polymer with a cyclic ester, hydroxy acid, ester of a hydroxy acid and/or cyclic amide, the acrylic pre-polymer may be formed by the aforementioned methods.

The acrylic material may be formed by a solution polymerisation method. Suitable solution polymerisation methods will be well to a person skilled in the art. The solution polymerisation method suitably comprises a plurality of components, which may be referred to as a solution polymerisation reaction mixture.

The solution polymerisation reaction mixture may comprise a monomer component. The monomer component may suitably comprise one or more acrylic monomer(s) as described above. The monomer component may optionally comprise one or more additional ethylenically unsaturated monomer(s) as described above.

The solution polymerisation reaction mixture may further comprise an initiator. The initiator may be a free radical initiator. Examples of suitable initiators include, but are not limited to, tertiary butyl perbenzoate; tert butyl peroxy 3,5,5 trimethylhexanoate; tertiary butyl peroxy 2-ethyl hexanoate; T-amyl peroxy 2-ethyl hexanoate; di tertiary butyl peroxide; tertiary butyl peracetate; tertiary butyl peroctoate; azo type initiators such as, for example, 2,2′-Azobis (isobutyronitrile), 2,2′-Azobis(2-methylbutyronitrile), 2,2′-Azobis(2,4-dimethyl valeronitrile) and 2,2′-Azobis(4-methoxy-2,4-dimethyl valeronitrile); persulphate initiators such as, for example, ammonium persulphate, sodium persulphate or potassium persulphate; and combinations thereof. The initiator may comprise 2,2′-Azobis(2-methylbutyronitrile). The initiator may be soluble in the solution polymerisation reaction mixture. The initiator may be soluble in the monomer component.

The solution polymerisation reaction mixture may comprise a solvent or mixture of solvents. Suitable solvents will be well known to a person skilled in the art. Examples of suitable solvents include, but are not limited to, aliphatic hydrocarbons such as mineral spirits and high flash point naphtha; 2,2-dimethoxypropane (DMP); Rhodiasolv (RTM) RPDE commercially available from Solvay; methyl ethyl ketone; methyl isobutyl ketone; cyclohexanone; aromatic hydrocarbons such as benzene; toluene; xylene; solvent naphtha 100, 150, 150ND, 200 and/or 200ND; those sold under the tradename SOLVESSO (RTM) commercially available from Exxon-Mobil Chemical Company; alcohols such as, for example, propanol, isopropanol, n-butanol, pentanol, hexanol or diacetone alcohol; glycols such as, for example, butyl glycol; glycol ethers such as, for example, 2-butoxy ethanol, 1-methoxy propan-2-ol; esters such as, for example, ethyl acetate, butyl acetate, n-hexyl acetate, dibasic ester commercially available from Sigma Aldrich, propylene glycol methyl ether acetate, butyl glycol acetate and butyl diglycol acetate; glycols such as butyl glycol and dibutyl glycol; glycol ethers such as methoxypropanol, ethylene glycol monomethyl ether, ethylene glycol monobutyl ether, propylene glycol methyl ether and dipropylene glycol mono methyl ether; and combinations thereof. The solvent may comprise a mixture of solvents, such as n-butanol and butyl glycol, for example. It will be appreciated by a person skilled in the art that the solvent or mixture of solvents may be chosen such that the monomer component is substantially soluble in said solvent or mixture of solvents.

The solution polymerisation reaction mixture may be substantially free, may be essentially free or may be completely free of alcohol solvents. By “substantially free” we mean to refer to reaction mixtures comprising less than 10 vol % alcohol solvents based on the total volume of solvent present. By “essentially free” we mean to refer to reaction mixtures comprising less than 5 vol % alcohol solvents based on the total volume of solvent present. By “completely free” we mean to refer to reaction mixtures comprising less than 1 vol % alcohol solvents based on the total volume of solvent present. The solution polymerisation reaction mixture may comprise 0 vol % alcohol solvent based on the total volume of solvent present. By using 0 wt % alcohol solvent in the solution polymerisation reaction mixture, the initiation of lactone and/or lactide polymerisation may be reduced or eliminated.

The monomer component is suitably caused to undergo polymerisation in the solvent or mixture of solvents to form the acrylic material. The solution polymerisation of the monomer component may be carried out as a free radical initiated solution polymerisation in a solvent or mixture of solvents.

Solution polymerisation may be carried out in a suitable reaction vessel. The monomer component, initiator and/or solvent or mixture of solvents may be added to the reaction vessel in any suitable order. For example, the solvent or mixture of solvents may be added to the reaction vessel before the monomer component and/or initiator are added to the reaction vessel. The monomer component and initiator may be added to the reaction vessel at the same time. The monomer component and/or initiator may be added to the reaction vessel over any suitable period of time. The monomer component and/or initiator may be added to the reaction vessel over a time period of 0 to 12 hours, such as 30 minutes to 8 hours, such as 1 hour to 6 hours, or even 2 hours to 4 hours. For the avoidance of doubt, when the monomer component and/or initiator are added over a time period of 0 hours, all of the monomer component and/or initiator are added at the same time (i.e. in one single addition).

Solution polymerisation may be carried out at any suitable temperature. Solution polymerisation may be carried out at an elevated temperature. Solution polymerisation may be carried out at a temperature from 80° C. to 200° C., such as from 80 to 180° C., such as from 80 to 160° C., such as from 80 to 150° C., such as from 80 to 140° C., such as from 80 to 130° C., such as from 80 to 120° C., such as 80 to 110° C., or even from 90 to 110° C. Solution polymerisation may be carried out at a temperature from 90 to 110° C. Solution polymerisation may be carried out at reflux. Solution polymerisation may be carried out at a temperature of 80° C. or above, such as 100° C. or above, such as 120° C. or above, such as 130° C. or above, or even 135° C. or above. Solution polymerisation may be carried out at a temperature of 250° C. or below, such as 200° C. or below, such as 180° C. or below, such as 160° C. or lower, such as 150° C. or lower, or even 145° C. or lower.

Alternatively, the acrylic material may be formed by atom transfer radical polymerisation (ATRP). The ATRP process can be described generally as comprising: polymerizing one or more radically polymerizable monomers in the presence of an initiation system; forming a polymer; and isolating the formed polymer. In the present invention, the initiation system comprises: a monomeric initiator having a single radically transferable atom or group; a transition metal compound, i.e. a catalyst, which participates in a reversible redox cycle with the initiator; and a ligand, which coordinates with the transition metal compound. The ATRP process is described in further detail in International Patent Publication No. WO 98/40415 and U.S. Pat. Nos. 5,807,937, 5,763,548 and 5,789,487, the entire contents of which are incorporated herein by reference.

Catalysts that may be used in the ATRP process include any transition metal compound that can participate in a redox cycle with the initiator and the growing polymer chain. The transition metal compound suitably does not form direct carbon-metal bonds with the polymer chain. Transition metal catalysts useful in the present invention may be represented by the following general formula II, Mⁿ+Xₙ, wherein M is the transition metal, n is the formal charge on the transition metal having a value of from 0 to 7, and X is a counterion or covalently bonded component. Examples of the transition metal M include, but are not limited to, Cu, Fe, Au, Ag, Hg, Pd, Pt, Co, Mn, Ru, Mo, Nb and Zn. The transition metal may comprise Cu. Examples of X include, but are not limited to, halide, hydroxy, oxygen, C₁-C₆-alkoxy, cyano, cyanato, thiocyanato and azido. The transition metal may comprise Cu(I) and X may comprise halide, e.g., chloride. The transition metal catalysts may comprise copper halides, e.g., Cu(I)Cl. The transition metal catalyst may contain a small amount, e.g., 1 mole percent, of a redox conjugate, for example, Cu(II)Cl₂ when Cu(I)Cl is used. Additional catalysts useful in preparing the acrylic material are described in U.S. Pat. No. 5,807,937 at column 18, lines 29 through 56, which is incorporated herein by reference. Redox conjugates are described in further detail in U.S. Pat. No. 5,807,937 at column 11, line 1 through column 13, line 38, which is incorporated herein by reference.

Ligands that may be used in the ATRP process include, but are not limited to, compounds having one or more nitrogen, oxygen, phosphorus and/or sulphur atoms, which can coordinate to the transition metal catalyst compound, e.g., through sigma and/or pi bonds. Classes of useful ligands include, but are not limited to, unsubstituted and substituted pyridines and bipyridines, such as 2,2′-bipyridyl; porphyrins; cryptands; crown ethers; e.g. 18-crown-6; polyamines, e.g. ethylenediamine and N,N-dimethylethylenediamine; glycols, e.g. alkylene glycols, such as ethylene glycol; carbon monoxide; and coordinating monomers, e.g. styrene, acrylonitrile and hydroxyalkyl (meth)acrylates. The ligand may comprise substituted bipyridines, e.g. 4,4′-dialkyl-bipyridyls. Additional ligands that may be used in preparing the acrylic material are described in U.S. Pat. No. 5,807,937 at column 18, line 57 through column 21, line 43, which is incorporated herein by reference.

The ligand may comprise a bipyridine, such as 2,2′-bipyridyl, and/or Me₆TREN (tris[2-dimethylamino)ethyl]amine).

The monomeric initiator may be selected from 1-halo-2,3-epoxypropane, p-toluenesulfonyl halide, p-toluenesulfenyl halide, C₆-C₂₀-alkyl ester of alpha-halo-C₂-C₆-carboxylic acid, halomethylbenzene, (1-haloethyl)benzene, halomethylnaphthalene, halomethylanthracene and mixtures thereof. Examples of C₂-C₆-alkyl esters of alpha-halo-C₂-C₆-carboxylic acids include, but are not limited to, hexyl alpha-bromopropionate, 2-ethylhexyl alpha-bromopropionate, 2-ethylhexyl alpha-bromohexionate and icosanyl alpha-bromopropionate. As used herein, the term “monomeric initiator” is meant to be distinguishable from polymeric initiators, such as polyethers, polyurethanes, polyesters and acrylic polymers having radically transferable groups.

The amounts and relative proportions of monomeric initiator, transition metal compound and ligand for the ATRP process are those for which ATRP is most effectively performed. The amount of initiator used can vary widely and is typically present in the reaction medium in a concentration of from 10⁻⁴ moles/litre (M) to 3 M, for example, from 10⁻³ M to 10⁻¹ M. As the molecular weight of the acrylic material can be directly related to the relative concentrations of initiator and monomer(s), the molar ratio of initiator to monomer is an important factor in polymer preparation. The molar ratio of initiator to monomer is typically within the range of 10⁻⁴:1 to 0.5:1, for example, 10⁻³:1 to 10⁻²:1.

The molar ratio of transition metal compound to initiator may be in the range of 10⁻⁴:1 to 10:1, for example, 0.1:1 to 5:1. The molar ratio of ligand to transition metal compound may be within the range of 0.1:1 to 100:1, for example 0.2:1 to 10:1.

The ATRP process may be carried out in the absence of solvent, i.e. by means of a bulk polymerisation process. Generally, the ATRP process may be carried out in the presence of a solvent, typically water and/or an organic solvent. Classes of useful organic solvents include, but are not limited to, esters of carboxylic acids, ethers such as propylene glycol methyl ether acetate, for example those sold under the tradename DOWANOL (RTM), for example DOWANOL PM Acetate commercially available from Dow, cyclic ethers, C5-C10 alkanes, C5-C8 cycloalkanes, aromatic hydrocarbon solvents, halogenated hydrocarbon solvents, amides, nitrites, sulfoxides, sulfones and mixtures thereof. Supercritical solvents, such as CO₂, C₁-C₄ alkanes and fluorocarbons may also be employed. The solvent may comprise aromatic hydrocarbon solvents, such as xylene, toluene, and mixed aromatic solvents, such as those sold under the tradename SOLVESSO (RTM), such as SOLVESSO 150 commercially available from Exxon Chemical America. Additional solvents are described in further detail in U.S. Pat. No. 5,807,937 at column 21, line 44 through column 22, line 54, which is incorporated herein by reference. The solvent may comprise propylene glycol methyl ether acetate and/or an aromatic solvent, such as SOLVESSO 150.

The ATRP process may be conducted at a reaction temperature from 25 to 200° C., such as from 50 to 180° C., such as from 70 to 170° C., and at a pressure from 1 to 100 atmospheres, such as ambient pressure.

The ATRP transition metal catalyst and its associated ligand may be separated or removed from the acrylic material prior to its use in the coating compositions of the present invention. Removal of the ATRP catalyst may be achieved using known methods, including, for example, adding a catalyst binding agent to the mixture of the acrylic material, solvent and catalyst, followed by filtering. Examples of suitable catalyst binding agents include, for example, alumina, silica, clay or a combination thereof. A mixture of the acrylic material, solvent and ATRP catalyst may be passed through a bed of catalyst binding agent. Alternatively, the ATRP catalyst may be oxidized and retained in situ.

Advantageously, the use of the ATRP process to prepare the acrylic materials of the present invention may mean that higher number average molecular weights than would typically be expected may be achieved.

As described above, the terminal and/or side group(s) of Formula (I) and/or (Ia) may be derived from the reaction between a hydroxyl, carboxylic acid, oxirane, amine and/or thiol group and a cyclic ester, hydroxy acid, ester of a hydroxy acid and/or cyclic amide, When the acrylic material is formed by the ATRP process, the hydroxyl, carboxylic acid, oxirane, amine and/or thiol groups are suitably reacted with a cyclic ester, hydroxy acid, ester of a hydroxy acid and/or cyclic amide after polymerisation.

Thus, the acrylic material of the present invention may be formed by a method comprising the steps of:
a) preparing an acrylic pre-polymer having one or more hydroxyl, carboxylic acid, oxirane, amine and/or thiol group(s) by atom transfer radical polymerisation (ATRP); and
b) reacting said hydroxyl, carboxylic acid, oxirane, amine and/or thiol functional group(s) of the acrylic pre-polymer with a cyclic ester, hydroxy acid, ester of a hydroxy acid and/or cyclic amide.

The acrylic material may be formed by a method comprising the steps of:
a) preparing an acrylic pre-polymer having one or more hydroxyl, carboxylic acid, amine and/or thiol functional group(s), such as hydroxyl and/or carboxylic acid groups, or even hydroxyl groups, by atom transfer radical polymerisation (ATRP); and
b) reacting said hydroxyl, carboxylic acid, amine and/or thiol group(s) of the acrylic pre-polymer with a cyclic ester, such as a lactone and/or lactide, and/or a cyclic amide, such as a lactam.

The acrylic material may be formed by a method comprising the steps of:
a) preparing an acrylic pre-polymer having one or more hydroxyl, carboxylic acid, amine and/or thiol functional group(s), such as hydroxyl and/or carboxylic acid groups, or even hydroxyl groups, by atom transfer radical polymerisation (ATRP); and
b) reacting said hydroxyl, carboxylic acid, amine and/or thiol group(s) of the acrylic pre-polymer with a cyclic ester, such as a lactone and/or lactide.

The acrylic material may have any suitable number average molecular weight (Mn). The acrylic material may have an Mn of at least 500 Daltons (Da=g/mole), such as at least 1,000 Da, such as at least 2,000 Da, such as at least 3,000 Da, such as at least 4,000 Da, such as at least 5,000 Da, such as at least 6,000 Da, such as at least 7,000 Da, such as at least 8,000 Da, such as at least 9,000 Da, or even at least 10,000 Da. The acrylic material may have an Mn up to 250,000 Da, such as up to 150,000 Da, such as up to 100,000 Da, such as up to 50,000 Da, such as up to 25,000 Da, such as up to 20,000 Da, such as up to 18,000 Da, or even up to 15,000 Da.

The acrylic material may have an Mn from 500 to 250,000 Da, such as from 1,000 to 250,000 Da, such as from 2,000 to 250,000 Da, such as from 3,000 to 250,000 Da, such as from 4,000 to 250,000 Da, such as from 5,000 to 250,000 Da, such as from 6,000 to 250,000 Da, such as from 7,000 to 250,000 Da, such as from 8,000 to 250,000 Da, such as from 9,000 to 250,000 Da, such as from 10,000 to 250,000 Da. The acrylic material may have an Mn from 500 to 150,000 Da, such as from 1,000 to 150,000 Da, such as from 2,000 to 150,000 Da, such as from 3,000 to 150,000 Da, such as from 4,000 to 150,000 Da, such as from 5,000 to 150,000 Da, such as from 6,000 to 150,000 Da, such as from 7,000 to 150,000 Da, such as from 8,000 to 150,000 Da, such as from 9,000 to 150,000 Da, such as from 10,000 to 150,000 Da. The acrylic material may have an Mn from 500 to 100,000 Da, such as from 1,000 to 100,000 Da, such as from 2,000 to 100,000 Da, such as from 3,000 to 100,000 Da, such as from 4,000 to 100,000 Da, such as from 5,000 to 100,000 Da, such as from 6,000 to 100,000 Da, such as from 7,000 to 100,000 Da, such as from 8,000 to 100,000 Da, such as from 9,000 to 100,000 Da, such as from 10,000 to 100,000 Da. The acrylic material may have an Mn from 500 to 50,000 Da, such as from 1,000 to 50,000 Da, such as from 2,000 to 50,000 Da, such as from 3,000 to 50,000 Da, such as from 4,000 to 50,000 Da, such as from 5,000 to 50,000 Da, such as from 6,000 to 50,000 Da, such as from 7,000 to 50,000 Da, such as from 8,000 to 50,000 Da, such as from 9,000 to 50,000 Da, such as from 10,000 to 50,000 Da. The acrylic material may have an Mn from 500 to 25,000 Da, such as from 1,000 to 25,000 Da, such as from 2,000 to 25,000 Da, such as from 3,000 to 25,000 Da, such as from 4,000 to 25,000 Da, such as from 5,000 to 25,000 Da, such as from 6,000 to 25,000 Da, such as from 7,000 to 25,000 Da, such as from 8,000 to 25,000 Da, such as from 9,000 to 25,000 Da, such as from 10,000 to 25,000 Da. The acrylic material may have an Mn from 500 to 20,000 Da, such as from 1,000 to 20,000 Da, such as from 2,000 to 20,000 Da, such as from 3,000 to 20,000 Da, such as from 4,000 to 20,000 Da, such as from 5,000 to 20,000 Da, such as from 6,000 to 20,000 Da, such as from 7,000 to 20,000 Da, such as from 8,000 to 20,000 Da, such as from 9,000 to 20,000 Da, such as from 10,000 to 20,000 Da. The acrylic material may have an Mn from 500 to 18,000 Da, such as from 1,000 to 18,000 Da, such as from 2,000 to 18,000 Da, such as from 3,000 to 18,000 Da, such as from 4,000 to 18,000 Da, such as from 5,000 to 18,000 Da, such as from 6,000 to 18,000 Da, such as from 7,000 to 18,000 Da, such as from 8,000 to 18,000 Da, such as from 9,000 to 18,000 Da, such as from 10,000 to 18,000 Da. The acrylic material may have an Mn from 500 to 15,000 Da, such as from 1,000 to 15,000 Da, such as from 2,000 to 15,000 Da, such as from 3,000 to 15,000 Da, such as from 4,000 to 15,000 Da, such as from 5,000 to 15,000 Da, such as from 6,000 to 15,000 Da, such as from 7,000 to 15,000 Da, such as from 8,000 to 15,000 Da, such as from 9,000 to 15,000 Da, such as from 10,000 to 15,000 Da.

The acrylic material may have an Mn from 2,000 to 20,000 Da, such as from 3,000 to 18,000 Da, or even from 4,000 to 15,000 Da.

The acrylic material may have an Mn from 10,000 to 60,000 Da, or even from 20,000 to 50,000 Da.

As reported herein, the Mn was determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. RI detector, solvent: unstabilised THF, retention time marker: toluene, sample concentration: 10 mg/ml).

All values for Mn reported herein were measured in this way.

The acrylic material may have any suitable weight average molecular weight (Mw). The acrylic material may have an Mw of at least 500 Daltons (Da=g/mole), such as at least 1,000 Da, such as at least 2,000 Da, such as at least 3,000 Da, such as at least 4,000 Da, such as at least 5,000 Da, such as at least 6,000 Da, such as at least 7,000 Da, such as at least 8,000 Da, such as at least 9,000 Da, or even at least 10,000 Da. The acrylic material may have an Mw up to 250,000 Da, such as up to 150,000 Da, such as up to 100,000 Da, such as up to 50,000 Da, such as up to 25,000 Da, such as up to 20,000 Da, such as up to 18,000 Da, or even up to 15,000 Da.

The acrylic material may have an Mw from 500 to 250,000 Da, such as from 1,000 to 250,000 Da, such as from 2,000 to 250,000 Da, such as from 3,000 to 250,000 Da, such as from 4,000 to 250,000 Da, such as from 5,000 to 250,000 Da, such as from 6,000 to 250,000 Da, such as from 7,000 to 250,000 Da, such as from 8,000 to 250,000 Da, such as from 9,000 to 250,000 Da, such as from 10,000 to 250,000 Da. The acrylic material may have an Mw from 500 to 150,000 Da, such as from 1,000 to 150,000 Da, such as from 2,000 to 150,000 Da, such as from 3,000 to 150,000 Da, such as from 4,000 to 150,000 Da, such as from 5,000 to 150,000 Da, such as from 6,000 to 150,000 Da, such as from 7,000 to 150,000 Da, such as from 8,000 to 150,000 Da, such as from 9,000 to 150,000 Da, such as from 10,000 to 150,000 Da. The acrylic material may have an Mw from 500 to 100,000 Da, such as from 1,000 to 100,000 Da, such as from 2,000 to 100,000 Da, such as from 3,000 to 100,000 Da, such as from 4,000 to 100,000 Da, such as from 5,000 to 100,000 Da, such as from 6,000 to 100,000 Da, such as from 7,000 to 100,000 Da, such as from 8,000 to 100,000 Da, such as from 9,000 to 100,000 Da, such as from 10,000 to 100,000 Da. The acrylic material may have an Mw from 500 to 50,000 Da, such as from 1,000 to 50,000 Da, such as from 2,000 to 50,000 Da, such as from 3,000 to 50,000 Da, such as from 4,000 to 50,000 Da, such as from 5,000 to 50,000 Da, such as from 6,000 to 50,000 Da, such as from 7,000 to 50,000 Da, such as from 8,000 to 50,000 Da, such as from 9,000 to 50,000 Da, such as from 10,000 to 50,000 Da. The acrylic material may have an Mw from 500 to 25,000 Da, such as from 1,000 to 25,000 Da, such as from 2,000 to 25,000 Da, such as from 3,000 to 25,000 Da, such as from 4,000 to 25,000 Da, such as from 5,000 to 25,000 Da, such as from 6,000 to 25,000 Da, such as from 7,000 to 25,000 Da, such as from 8,000 to 25,000 Da, such as from 9,000 to 25,000 Da, such as from 10,000 to 25,000 Da. The acrylic material may have an Mw from 500 to 20,000 Da, such as from 1,000 to 20,000 Da, such as from 2,000 to 20,000 Da, such as from 3,000 to 20,000 Da, such as from 4,000 to 20,000 Da, such as from 5,000 to 20,000 Da, such as from 6,000 to 20,000 Da, such as from 7,000 to 20,000 Da, such as from 8,000 to 20,000 Da, such as from 9,000 to 20,000 Da, such as from 10,000 to 20,000 Da. The acrylic material may have an Mw from 500 to 18,000 Da, such as from 1,000 to 18,000 Da, such as from 2,000 to 18,000 Da, such as from 3,000 to 18,000 Da, such as from 4,000 to 18,000 Da, such as from 5,000 to 18,000 Da, such as from 6,000 to 18,000 Da, such as from 7,000 to 18,000 Da, such as from 8,000 to 18,000 Da, such as from 9,000 to 18,000 Da, such as from 10,000 to 18,000 Da. The acrylic material may have an Mw from 500 to 15,000 Da, such as from 1,000 to 15,000 Da, such as from 2,000 to 15,000 Da, such as from 3,000 to 15,000 Da, such as from 4,000 to 15,000 Da, such as from 5,000 to 15,000 Da, such as from 6,000 to 15,000 Da, such as from 7,000 to 15,000 Da, such as from 8,000 to 15,000 Da, such as from 9,000 to 15,000 Da, such as from 10,000 to 15,000 Da.

As reported herein, the Mw was determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. RI detector, solvent: unstabilised THF, retention time marker: toluene, sample concentration: 10 mg/ml).

All values for Mw reported herein were measured in this way.

The acrylic material may have any suitable polydispersity index. The polydispersity index of a polymer is given by the ratio of Mw to Mn (Mw/Mn), wherein Mw is the weight average molecular weight and Mn is the number average molecular weight. The acrylic material may have any suitable polydispersity index. The acrylic material may have a polydispersity index of at least 1, such as at least 1.2, or even at least 1.5. The acrylic material may have a polydispersity index up to 80, such as up to 60, such as up to 40, such as up to 20, such as up to 15, such as up to 10, such as up to 8, such as up to 5. The acrylic material may have a polydispersity index from 1 to 80, such as from 1 to 60, such as from 1 to 40, such as from 1 to 20, such as from 1 to 15, such as from 1 to 10, such as from 1 to 10, such as from 1 to 8, or even from 1 to 5. The acrylic material may have a polydispersity index from 1.2 to 80, such as from 1.2 to 60, such as from 1.2 to 40, such as from 1.2 to 20, such as from 1.2 to 15, such as from 1.2 to 10, such as from 1.2 to 10, such as from 1.2 to 8, or even from 1.2 to 5. The acrylic material may have a polydispersity index from 1.5 to 80, such as from 1.5 to 60, such as from 1.5 to 40, such as from 1.5 to 20, such as from 1.5 to 15, such as from 1.5 to 10, such as from 1.5 to 10, such as from 1.5 to 8, or even from 1.5 to 5.

The acrylic material may have a polydispersity index from 1.2 to 15, such as from 1.5 to 10, or even from 1.5 to 8.

The acrylic material may have pendant hydroxyl groups such that it is hydroxyl-functional. The acrylic material may have any suitable hydroxyl value (OHV, also known as hydroxyl number or ‘OHN’). The acrylic material may have an OHV of at least 10 mg KOH/g, such as at least 20 mg KOH/g, such as at least 30 mg KOH/g, or even at least 35 mg KOH/g. The acrylic material may have an OHV up to 150 mg KOH/g, such as up to 120 mg KOH/g, such as up to 100 mg KOH/g, or even up to 80 mg KOH/g.

The acrylic material may have an OHV from 10 to 150 mg KOH/g, such as from 20 to 150 mg KOH/g, such as from 30 to 150 mg KOH/g, or even from 35 to 150 mg KOH/g. The acrylic material may have an OHV from 10 to 120 mg KOH/g, such as from 20 to 120 mg KOH/g, such as from 30 to 120 mg KOH/g, or even from 35 to 120 mg KOH/g. The acrylic material may have an OHV from 10 to 100 mg KOH/g, such as from 20 to 100 mg KOH/g, such as from 30 to 100 mg KOH/g, or even from 35 to 100 mg KOH. The acrylic material may have an OHV from 10 to 80 mg KOH/g, such as from 20 to 80 mg KOH/g, such as from 30 to 80 mg KOH/g, or even from 35 to 80 mg KOH/g.

The hydroxyl value (OHV) is suitably expressed on solids. All values for OHV provided herein are expressed on solids unless specified otherwise.

The acrylic material may have an OHV of at least 10 mg KOH/g.

The acrylic material may have an OHV from 10 to 150 mg KOH/g, such as from 20 to 120 mg KOH/g, such as from 30 to 100 mg KOH/g, or even from 35 to 80 mg KOH/g.

For the avoidance of doubt, when the acrylic material has one or more terminal and/or side group(s) of Formula (I), the acrylic material may have the aforementioned hydroxyl values when the Y atom(s) of Formula (I) are oxygen (O) or otherwise (for example, when one or more of the Y atoms are nitrogen (N) and/or sulphur(S)).

As reported herein, the hydroxyl number expressed on solids is the number of mg of KOH equivalent to the hydroxyl groups in 1 g of material. In such as method, a sample (typically, 0.1 to 3 g) was weighed accurately into a conical flask and is dissolved, using light heating and stirring as appropriate, in 20 ml of tetrahydrofuran. 10 ml of 0.1M 4-(dimethylamino)pyridine in tetrahydrofuran (catalyst solution) and 5 ml of a 9 vol % solution of acetic anhydride in tetrahydrofuran (i.e. 90 ml acetic anhydride in 910 ml tetrahydrofuran; acetylating solution) were then added to the mixture. After 5 minutes, 10 ml of an 80 vol % solution of tetrahydrofuran (i.e. 4 volume parts tetrahydrofuran to 1 part distilled water; hydrolysis solution) was added. After 15 minutes, 10 ml tetrahydrofuran was added and the solution is titrated with 0.5M ethanolic potassium hydroxide (KOH). A blank sample was also run where the sample of solid polyester is omitted. The resulting hydroxyl number is expressed in units of mg KOH/g and is calculated using the following equation:

Hydroxyl number=((V2−V1)×molarity of KOH solution(M)×56.1)/weight of solid sample(g)

wherein V1 is the titre of KOH solution (ml) of the polyester sample and V2 is the titre of KOH solution (ml) of the blank sample.

All values for hydroxyl value reported herein were measured in this way.

The acrylic material may have any suitable acid value (AV). The acrylic material may have an AV up to 100 mg KOH/g, such as up to 75 mg KOH/g, such as up to 50 mg KOH/g, such as up to 40 mg KOH/g, such as up to 30 mg KOH/g, such as up to 20 mg KOH/g, such as up to 10 mg KOH/g, or even up to 5 mg KOH/g.

The acid value (AV) is suitably expressed on solids.

As reported herein, the acid value (AV) expressed on solids was determined by titration with 0.1M methanolic potassium hydroxide (KOH) solution. A sample of solid polymer (0.1 to 3 g depending on acid number) was weighed accurately into a conical flask and is dissolved, using light heating and stirring as appropriate, in 25 ml of dimethyl formamide containing phenolphthalein indicator. The solution was then cooled to room temperature and titrated with the 0.1M methanolic potassium hydroxide solution. The resulting acid number is expressed in units of mg KOH/g and is calculated using the following equation:

Acid value=titre of KOH solution(ml)×molarity KOH solution(M)×56.1weight of solid sample(g)

All values for acid value reported herein were measured in this way.

The acrylic material may have any suitable glass transition temperature (Tg). The acrylic material may have a Tg from −20 to 100° C., such as from −10 to 90° C., such as from 0 to 80° C., such as from 10 to 70° C., such as from 10 to 50° C., such as from 10 to 40° C., or even from 10 to 30° C.

As reported herein, the Tg was measured according to ASTM D6604-00 (2013) (“Standard Practice for Glass Transition Temperatures of Hydrocarbon Resins by Differential Scanning calorimetry”. Heat-flux differential scanning calorimetry (DSC), sample pans: aluminium, reference: blank, calibration: indium and mercury, sample weight: 10 mg, heating rate: 20° C./min).

All values for Tg reported herein were measured in this way.

The coating composition comprises a crosslinker material operable to crosslink the hydroxyl, amine and/or thiol functionality on the acrylic material. The coating composition may comprise any suitable crosslinker material operable to crosslink the hydroxyl, amine and/or thiol functionality on the acrylic material. Suitable crosslinker materials will be well known to a person skilled in the art.

Suitable crosslinker materials include, but are not limited to, the following: phenolic resins (or phenol-formaldehyde resins); aminoplast resins (or triazine-formaldehyde resins); amino resins; epoxy resins; epoxy-mimic resins, such as those based on bisphenols and other bisphenol A (BPA) replacements; isocyanate resins, isocyanurate resins, such as triglycidylisocyanurate; hydroxy (alkyl) amide resins, such as B-hydroxy (alkyl) amide resins; hydroxy (alkyl) urea resins; carbodiimide resins, such as polycarbodiimide resins; oxazolines; and combinations thereof.

The crosslinker material may comprise a phenolic resin.

The crosslinker material may comprise a phenolic resin, an isocyanate resin and/or benzoguanamine and/or derivatives thereof, such as a phenolic resin and an isocyanate, such as a phenolic resin and benzoguanamine and/or derivatives thereof, or even a phenolic resin, an isocyanate resin and benzoguanamine and/or derivatives thereof.

Non-limiting examples of phenolic resins are those formed from the reaction of a phenol with an aldehyde or a ketone, such as from the reaction of a phenol with an aldehyde, such as from the reaction of a phenol with formaldehyde or acetaldehyde, or even from the reaction of a phenol with formaldehyde. Non-limiting examples of phenols which may be used to form phenolic resins are phenol, butyl phenol, xylenol and cresol. General preparation of phenolic resins is described in “The Chemistry and Application of Phenolic Resins or Phenoplasts”, Vol V, Part I, edited by Dr Oldring; John Wiley and Sons/Cita Technology Limited, London, 1997. The phenolic resins are of the resol type. By “resol type” is meant resins formed in the presence of a basic (alkaline) catalyst and optionally an excess of formaldehyde. Examples of suitable commercially available phenolic resins include, but are not limited to, those sold under the trade name PHENODUR (RTM) commercially available from Cytec Industries, such as PHENODUR EK-827, PHENODUR VPR1785, PHENODUR PR 515, PHENODUR PR516, PHENODUR PR 517, PHENODUR PR 285, PHENODUR PR612, PHENODUR 520, PHENODUR 307 or PHENODUR PH2024; resins sold under the trade name BAKELITE (RTM) commercially available from Momentive, such as BAKELITE 6582 LB, BAKELITE 6535, BAKELITE PF9989, BAKELITE PF 7295 LB, BAKELITE 6736 LG, BAKELITE 6572 LB or BAKELITE PF6581; SFC 112 commercially available from Schenectady; DUREZ (RTM)33356 commercially available from SHHPP; Curaphen 40-862 commercially available from Bitrez; BDP2220/DF0181 commercially available from Bitrez; BURNOCK PH2891 commercially available from DIC Corporation; Askofen R9500 commercially available from Ask Chemicals; or combinations thereof.

Non limiting examples of isocyanate resins include blocked and/or unblocked isocyanate resins. The isocyanate resin may comprise a blocked isocyanate resin. Examples of suitable blocked isocyanate resins include, but are not limited to, blocked isocyanates based on isophorone diisocyanate (IPDI), such as those sold under the trade name DESMODUR (RTM) commercially available from Covestro, for example DESMODUR VP-LS 2078/2 or DESMODUR PL 340 or those sold under the trade name VESTANAT (RTM) commercially available from Evonik, for example VESTANANT B 1370, VESTANAT B 118 6A or VESTANAT B 1358 A; blocked aliphatic polyisocyanate based on hexamethylene diisocyanate (HDI), such as those sold under the trade name DESMODUR (RTM) commercially available from Covestro, for example DESMODUR BL3370 or DESMODUR BL 3175 SN, those sold under the trade name DURANATE (RTM) commercially available from Asahi KASEI, for example DURANATE MF-K60X, those sold under the trade name TOLONATE (RTM) commercially available from Perstorp, for example TOLONATE D2 or those sold under the trade name TRIXENE (RTM) commercially available from Baxenden, for example TRIXENE-BI-7984 or TRIXENE 7981; or combinations thereof.

Non-limiting examples of aminoplast resins include those which are formed from the reaction of a triazine such as melamine or benzoguanamine with formaldehyde. The resultant compounds may be etherified with an alcohol such as methanol, ethanol, butanol or combinations thereof. The preparation and use of aminoplast resins is described in “The Chemistry and Applications of Amino Crosslinking Agents or Aminoplast”, Vol V, Part II, page 21 ff., edited by Dr Oldring; John Wiley and Sons/Cita Technology Limited, London, 1998. Examples of suitable commercially available aminoplast resins include, but are not limited to, those sold under the tradename MAPRENAL (RTM) such as MAPRENAL MF980, MF 820/60IB or 821/84B commercially available from Prefere Resins and those sold under the tradename CYMEL (RTM) such as CYMEL 303, CYMEL 651E and CYMEL 1128 commercially available from Allnex.

The crosslinker material may comprise benzoguanamine and/or derivatives thereof. The benzoguanamine and/or derivatives thereof may comprise commercially available benzoguanamine and/or derivatives thereof. Suitable examples of commercially available benzoguanamine and its derivatives include, but are not limited to, benzoguanamine-formaldehyde based materials such as those sold under the tradename CYMEL, for example CYMEL® 1123 commercially available from Allnex; those sold under the tradename TAMIN (RTM), for example TAMIN BG143 commercially available from Galstaff Multiresine; those sold under the tradename MAPRENAL (RTM), for example MAPRENAL BF892 and MAPRENAL BF891 commercially available from Prefere Resins; glycoluril based materials, such as those sold under the tradename CYMEL (RTM), for example CYMEL 1170 and CYMEL 1172 commercially available from Allnex; those sold under the tradename ZUPRACURE (RTM), for example ZUPRACURE QM-432-72 commercially available from Qualimer Co., LTD; and combinations thereof.

The crosslinker material may contain nitrogen, which may be in the form of an amine or amide material. The crosslinker material may comprise a hydroxyl substituted amine or amide material. The crosslinker material may comprise a hydroxyalkylamide material, such as a β-hydroxyalkylamide material. Examples of suitable hydroxyalkylamide materials are disclosed in WO 2017/121879, the entire contents of which is incorporated herein by reference, and in particular from page 13, line 4 to page 14, line 11 of WO 2017/121879.

The hydroxyalkylamide crosslinker may comprise a polyhydroxyalkylamide material, such as a polyhydroxyalkylamide having the Formula (VI):

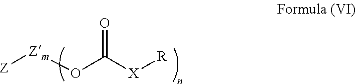

wherein, with reference to Formula (VI), Z represents a polymer or an alkylene, alkenylene, alkynylene or arylene group; Z′ represents a bivalent organic linking group; m is 0 or 1; X represents a bivalent organic bridging group; R represents a hydroxyalkylamide group; and n is at least 2.

Examples of suitable polyhydroxyalkylamide materials are disclosed in WO2020/123893, the entire contents of which are incorporated herein by reference.

The crosslinker material may be in the form of a urea material. The crosslinker material may comprise a hydroxyl substituted urea material.

The crosslinker material may comprise a hydroxy functional alkyl polyurea material.

The crosslinker material may contain a terminal chemical group as shown in Formula (VII).

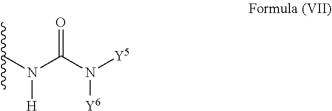

wherein Y⁵ and Y⁶ each, independently, represent hydrogen, an alkyl or a hydroxy functional alkyl having two or more carbon atoms and at least one of Y⁵ and Y⁶ is a hydroxyl functional alkyl having two or more carbon atoms.

The Y⁵ and Y⁶ groups may exclude ether linkages.

The terminal chemical group of Formula (VII) may be connected to a further chemical structure, not shown. Additionally or alternatively, the chemical group of Formula (VII) may be suspended from a carrier substrate, such as a silica carrier substrate, for example.

The crosslinker material may contain a plurality of terminal chemical groups as shown in Formula (VII). For example, the crosslinker may contain 2 to 6 terminal chemical groups as shown in Formula (VII), such as 2, 3 or 4 terminal chemical groups as shown in Formula (VII).

Examples of suitable hydroxy functional alkyl polyureas are disclosed in WO2017/123955, the entire contents of which are incorporated herein by reference, and in particular from paragraph to of WO2017/123955.

The crosslinker material may be in the form of a carbodiimide resin. The crosslinker may comprise a polycarbodiimide. Examples of suitable carbodiimide crosslinker materials are disclosed in WO2017/122171, the entire contents of which are incorporated herein by reference, and in particular in paragraphs [0005], and to of WO2017/122171.

The crosslinker material may comprise the reaction product of a reaction mixture comprising:
(i) a cyclic unsaturated acid anhydride and/or diacid derivative thereof;
(ii) an ethylenically unsaturated monomer; and
(iii) an alcohol, amine, thiol and/or water,
   wherein at least a portion of the cyclic unsaturated acid anhydride and/or diacid derivative thereof is reacted with the alcohol, amine, thiol and/or water; and wherein the crosslinker material has an acid number of at least 100 mg KOH/g. Examples of suitable crosslinkers of this type are disclosed in WO 2021/195440, the entire contents of which are incorporated herein by reference, and in particular in paragraphs and to of WO 2021/195440.

The crosslinker material may comprise the reaction product of a reaction mixture comprising:
(i) ≥70% by weight of a cyclic unsaturated acid anhydride and/or diacid derivative thereof by total solid weight of the monomers from which the crosslinker material is formed;
(ii) optionally, an ethylenically unsaturated monomer;
(iii) and optionally, an alcohol, amine, thiol and/or water,
   wherein at least a portion of the cyclic unsaturated acid anhydride and/or diacid derivate thereof is reacted with the alcohol, amine, thiol and/or water, when present; and wherein the crosslinker material has an acid number of at least 100 mg KOH/g. Examples of suitable crosslinkers of this type are disclosed in WO 2021/195329, the entire contents of which are incorporated herein by reference, and in particular in paragraphs and to of WO 2021/195329.

The crosslinker material may be substantially free, may be essentially free or may be completely free of formaldehyde. By “substantially free” we mean to refer to crosslinker material containing less than 1000 parts per million (ppm) of any of the compounds or derivatives thereof mentioned above. By “essentially free” we mean to refer to crosslinker material containing less than 100 ppm of any of the compounds or derivatives thereof mentioned above. By “completely free” we mean to refer to crosslinker material containing less than 20 parts per billion (ppb) of any of the compounds or derivatives thereof. The crosslinker material may comprise 0 wt % of formaldehyde.

The coating composition is a solvent-borne coating composition. Thus, the coating composition comprises a carrier comprising a solvent. The coating composition may comprise any suitable solvent. The coating composition may comprise a single solvent or a mixture of solvents.

The solvent suitably has sufficient volatility to essentially entirely evaporate from the coating composition during the curing process. As a non-limiting example, the curing process may be by heating at from 130-230° C. for from 1-15 minutes.

Suitable organic solvents include, but are not limited to, aliphatic hydrocarbons such as mineral spirits and high flash point naphtha; aromatic hydrocarbons such as benzene; toluene; xylene; solvent naphtha 100, 150, 150ND, 200 and/or 200ND; those available from Exxon-Mobil Chemical Company under the SOLVESSO (RTM) trade name; alcohols such as ethanol, n-propanol, isopropanol, n-butanol, 2-butoxy ethanol and 1-methoxy propan-2-ol; ketones such as acetone, cyclohexanone, methylisobutyl ketone and methyl ethyl ketone; esters such as ethyl acetate, butyl acetate, n-hexyl acetate, dibasic ester commercially available from Sigma Aldrich, propylene glycol methyl ether acetate, butyl glycol acetate, butyl diglycol acetate and RHODIASOLV (RTM) RPDE (a blend of succinic and adipic esters commercially available from Solvay); glycols such as butyl glycol and dibutyl glycol; glycol ethers such as methoxypropanol, ethylene glycol monomethyl ether, ethylene glycol monobutyl ether, propylene glycol methyl ether and dipropylene glycol mono methyl ether; and combinations thereof.

The solvent may be used in the coating composition in amounts from 5 to 90 wt %, such as from 10 to 80 wt %, such as from 20 to 70 wt %, such as from 30 to 60 wt %, or even from 40 to 60 wt % based on the total solid weight of the coating composition. The solvent, when present, may be used in the coating composition in amounts from 40 to 60 wt % based on the total solid weight of the coating composition.

The coating composition may be substantially free, may be essentially free or may be completely free of water. By “substantially free” we mean to refer to coating compositions containing less than 10 vol % water based on the total volume of carrier. By “essentially free” we mean to refer to coating compositions containing less than 5 vol % water based on the total volume of carrier. By “completely free” we mean to refer to coating compositions containing less than 1 vol % water based on the total volume of the carrier. The coating composition may comprise 0 vol % water based on the total volume of the carrier.

The coating composition may further comprise a neutraliser. Examples of suitable neutralisers include those described herein in relation to the crosslinker material.

The coating composition may further comprise a catalyst. Any catalyst typically used to catalyse crosslinking reactions between the acrylic material and the crosslinker material may be used. Suitable catalysts will be known to a person skilled in the art. The catalyst may be a non-metal or a metal catalyst or a combination thereof. Examples of suitable non-metal catalysts include, but are not limited to, phosphoric acid; blocked phosphoric acid; alkylbenzene sulphonic acid; phosphatised resins such as, for example, phosphatised epoxy resins and phosphatised acrylic resins; those sold under the tradename CYCAT (RTM), such as CYCAT XK 406 N and CYCAT 600 commercially available from Allnex; sulfuric acid; sulfonic acid; those sold under the tradename NACURE (RTM), such as NACURE 5076, NACURE 296B, NACURE 5925 and NACURE XC 235 commercially available from King industries; and combinations thereof. Examples of suitable metal catalysts will be known to the person skilled in the art. Examples of suitable metal catalysts include, but are not limited to, tin containing catalysts, such as monobutyl tin tris(2-ethylhexanoate); zirconium containing catalysts, such as those sold under the tradename KKAT (RTM), for example KKAT 4205 commercially available from King Industries, and those sold under the tradename TIB KAT (RTM), for example TIB KAT 813 commercially available from Tib Chemicals; zinc containing catalysts such as those sold under the tradename KKAT (RTM), for example, KKAT 633 and KKAT 672 commercially available from King Industries, those sold under the tradename Borchi (RTM), for example Borchi Kat 15 commercially available from Borchers, and those sold under the tradename TIB KAT (RTM), for example TIB KAT 634 and TIB KAT 635 commercially available from Tib Chemicals; titanate based catalysts, such as tetrabutyl titanate TnBT (commercially available from Sigma Aldrich); and combinations thereof.

The catalyst, when present, may be used in the coating composition in any suitable amount. The catalyst, when present, may be used in amounts from 0.001 to 10 wt %, such as from 0.001 to 5 wt %, such as from 0.01 to 5 wt %, such as from 0.05 to 3 wt %, such as from 0.1 to 2 wt %, or even from 0.1 to 1 wt % based on the total solid weight of the coating composition.

The coating composition may comprise a further resin material. Suitable further resin materials will be well known to a person skilled in the art. Examples of suitable further resin materials include, but are not limited to, polyester resins; acrylic resins; polyvinyl chloride (PVC) resins; alkyd resins; polyurethane resins; polysiloxane resins; epoxy resins or combinations thereof.

The further resin material may comprise an adhesion promoter. Examples of suitable adhesion promoters include, but are not limited to, phosphoric acid or derivatives thereof; acid-functional polyesters such as those sold under the tradename Tego (RTM), for example Tego addbond LP 1600, LP1611, LTW, LTW-B, LTH, 2440, 2220, 2325 and DS 1300 commercially available from Evonik and those sold under the tradename Domopol (RTM), for example Domopol 5144 commercially available from Helios; acid-functional acrylics, epoxy resins, such as epoxy-mimic resins and epoxy-functional acrylics; siloxanes such as those sold under the tradename Geniosil (RTM), for example Geniosil GF93 commercially available from Wacker; silanes such as those sold under the tradename Dowsil (RTM) commercially available from Dow Chemical and those sold under the tradename Xiameter (RTM) commercially available from Dow Chemical; glycolurils such as those sold under the tradename Cymel, for example Cymel 1170 commercially available from Allnex; those sold under the tradename BYK (RTM), for example BYK 4500, 4510, 4511 and 4512 commercially available from BYK Chemie; those sold under the tradename Nebores (RTM), for example Nebores VAM MCH commercially available from Safic-alcan; and combinations thereof. The coating composition may comprise any suitable amount of adhesion promoter. The coating composition may comprise from 0.001 wt % to 10 wt %, such as from 0.01 to 5 wt %, such as from 0.05 to 3 wt %, such as from 0.1 to 2 wt %, such as from 0.1 to 1 wt %, or even from 0.1 to 0.5 wt % of adhesion promoter based on the total solid weight of the coating composition.

The adhesion promoter may comprise a polyester material comprising the reaction product of a reaction mixture comprising: (i) a polyacid, (ii) a polyol and (iii) a phosphorous acid.

The polyester material may comprise the reaction product of a mixture comprising a precursor polyester resin with a phosphorous acid. The precursor polyester resin may have a hydroxyl number from 20 to 75 mg KOH/g. The precursor polyester resin may have an acid value of 15 to 20 mg KOH/g. The precursor polyester resin may have a number average molecular weight (Mn) from 2,000 to 10,000 Da. The precursor polyester resin may comprise the reaction product of a reaction mixture comprising a polyacid and a polyol. The precursor polyester resin may comprise the reaction product of a reaction mixture comprising a polyacid or anhydride and at least one polyol, such as a mixture of diols and/or triols. The polyacid may comprise an alpha, beta-ethylenically unsaturated polycarboxylic acid or anhydride. The precursor polyester resin may comprise the reaction product of a reaction mixture comprising an alpha, beta-ethylenically unsaturated polycarboxylic acid and a polyol, such as a mixture of a diol and triol. The polyacid may comprise an alpha, beta-ethylenically unsaturated polycarboxylic and an aromatic and/or aliphatic polyacid. As such, the precursor polyester resin may comprise the reaction product of a reaction mixture comprising an alpha, beta-ethylenically unsaturated polycarboxylic acid, an aromatic and/or aliphatic polyacid and a polyol, such as a mixture of a diol and triol. The polyol and polyacid may be combined in desired proportions and chemically reacted using standard esterification (condensation) procedures to provide a precursor polyester resin having both hydroxyl and carboxylic acid groups. A triol may be used to provide a branched, as opposed to linear, precursor polyester resin.

Examples of suitable polyacids include, but are not limited to, maleic anhydride; maleic acid; fumaric acid; itaconic acid; phthalic acid; phthalic anhydride; isophthalic acid; trimellitic anhydride; terephthalic acid; naphthalene dicarboxylic acid; adipic acid; azelaic acid; succinic acid; sebacic acid; and combinations thereof. When used, the aromatic and/or aliphatic polyacid may be used in amounts of up to 70 wt %, such as from 50 to 65 wt % based on total solid weight of the polyacid. Examples of suitable diols, triols and polyols include, but are not limited to, ethylene glycol; propylene glycol; 1,3-propanediol, glycerol; diethylene glycol; dipropylene glycol; triethylene glycol; trimethylolpropane; trimethylolethane; tripropylene glycol; neopentyl glycol; pentaerythritol; 1,4-butanediol; trimethylol propane; hexylene glycol; cyclohexane dimethanol; polyethylene; polypropylene glycol; and combinations thereof. As mentioned above, the polyol component may be a mixture of a diol and a triol. Any suitable weight ratio of diol to triol may be used. The weight ratio of diol to triol may be from 0.5 to 10 to 1.

The equivalent ratio of polyol to polyacid may be from 0.9 to 1.1 to 1.0.

The phosphorus acid which is reacted with the precursor polyester resin may be phosphinic acid, phosphonic acid or phosphoric acid. The phosphorous acid may be phosphoric acid. The phosphoric acid may be in the form of an aqueous solution, such as orthophosphoric acid, which may be approximately 85.5 vol %, for example. As a further non-limiting example, the phosphoric acid may be 100 vol % phosphoric acid or super phosphoric acid. The phosphoric acid may be a condensation product, such as, for example, pyrophosphoric acid, metaphosphoric acid or phosphoric anhydride. The phosphorous acid, such as phosphoric acid, may be provided in amounts of 0.2 to 0.5 equivalents of phosphorous acid per hydroxyl equivalent of the precursor polyester resin, i.e., 0.2 to 0.45 P—OH groups per hydroxyl group.

The reaction of the phosphorus acid with the precursor polyester resin may be conducted in organic solvent. The organic solvent may be an aromatic solvent, a ketone or an ester having a boiling point of 65 to 250° C. Examples of suitable solvents include, for example, methyl ethyl ketone, methyl isobutyl ketone, butyl glycol acetate, methoxypropyl acetate and combinations thereof. The organic solvent for the reaction may be present in any suitable amount. The organic solvent for the reaction may be present in amounts from 20 to 50 wt % based on total weight of phosphorus acid, precursor polyester resin and organic solvent. The reactants and the organic solvent may be mixed at any suitable temperature. The reactants and the organic solvent may be mixed at a temperature from 50 to 95° C. Once the reactants are contacted, the reaction mixture may be maintained at any suitable temperature, such as at a temperature of from 90 to 200° C. The reaction may be allowed to proceed for any suitable period of time, such as from 45 minutes to 6 hours.

The adhesion promoter may comprise phosphoric acid or derivatives thereof. Derivatives of phosphoric acid include, but are not limited to, blocked phosphoric acid; phosphatised resins such as, for example, phosphatised epoxy resins and phosphatised acrylic resins; and combinations thereof. The coating composition may comprise phosphoric acid.

The coating compositions may comprise other optional materials well known in the art of formulating coatings, such as colorants, plasticizers, abrasion-resistant particles, anti-oxidants, hindered amine light stabilizers, UV light absorbers and stabilizers, surfactants, flow control agents, thixotropic agents, fillers, organic co-solvents, reactive diluents, catalysts, grind vehicles, lubricants, waxes and other customary auxiliaries.

As used herein, the term “colorant” means any substance that imparts colour and/or other opacity and/or other visual effect to the composition. The colorant can be added to the coating compositions in any suitable form, such as discrete particles, dispersions, solutions and/or flakes. A single colorant or a mixture of two or more colorants can be used in the coating compositions of the present invention. Suitable colorants are listed in U.S. Pat. No. 8,614,286, column 7, line 2 through column 8, line 65, which is incorporated by reference herein. Examples for packaging coating compositions are those approved for food contact, such as titanium dioxide; iron oxides, such as black iron oxide; aluminium paste; aluminium powder such as aluminium flake; carbon black; ultramarine blue; phthalocyanines, such as phthalocyanine blue and phthalocyanine green; chromium oxides, such as chromium green oxide; graphite fibrils; ferried yellow; quindo red; and combinations thereof, and those listed in Article 178.3297 of the Code of Federal Regulations, which is incorporated by reference herein.

The colorant, when present, may be used in the coating composition in any suitable amount. The colorant, when present, may be used in the coating composition in amounts up to 90 wt %, such as up to 50 wt %, or even up to 10 wt % based on the total solid weight of the coating composition.

Suitable lubricants will be known to the person skilled in the art. Examples of suitable lubricants include, but are not limited to, lanolin wax, polytetrafluoroethylene (PTFE) wax, such as Lanco TF 1780 commercially available from Lubrizol, carnauba wax, polyethylene type lubricants such as polyethylene wax, for example, Lanco SF 1500, commercially available from Lubrizol, micro crystalline wax, such as Lubaprint 121/F commercially available from Munzing, Ceracol 615 commercially available from BYK; and combinations thereof. The lubricant, when present, may be used in the coating composition in amounts of at least 0.01 wt % based on the total solid weight of the coating composition.

Surfactants may optionally be added to the coating composition in order to aid in flow and wetting of the substrate. Suitable surfactants will be known to the person skilled in the art. The surfactant, when present, may be chosen to be compatible with food and/or beverage packaging applications. Examples of suitable surfactants include, but are not limited to, alkyl sulphates (e.g., sodium lauryl sulphate); ether sulphates; phosphate esters; sulphonates; and their various alkali, ammonium, amine salts; aliphatic alcohol ethoxylates; alkyl phenol ethoxylates (e.g. nonyl phenol polyether); salts; polyether siloxane copolymers, such as those sold under the tradename Tego Glide (RTM), for example Tego Glide B 1484 commercially available from Evonik; polysiloxanes such as those sold under the tradename Borchi (RTM), for example Borchi Gol 1376 commercially available from Borchers, those sold under the tradename BYK (RTM), for example BYK 313 and BYK 370 commercially available from BYK Chemie and those sold under the tradename Tego Glide (RTM), for example Tego Glide 496 commercially available from Evonik; polyvinyl polymers, such as those sold under the tradename Dynoadd (RTM), for example Dynoadd F300 commercially available from Dynea; silicon polyesters, such as those sold under the tradename Silikoftal (RTM), for example Silikoftal HTT commercially available from Evonik and/or combinations thereof. The surfactants, when present, may be present in amounts from 0.01 wt % to 10 wt %, such as from 0.01 to 5 wt %, or even from 0.01 to 2 wt % based on the total solid weight of the coating composition.

Suitable plasticizers will be known to the person skilled in the art. Examples of suitable plasticizers include, but are not limited to, esters, such as those sold under the tradename Dioplex (RTM), for example Dioplex 907 commercially available from Hallstar; polybutadiene diols, such as those sold under the tradename Krasol (RTM), for example Krasol F3000 commercially available from Cray Valley and those sold under the tradename Poly bd (RTM), for example Poly bd 605E and Poly bd R45HTLO commercially available from Total; epoxidized soy bean oil, such as EFKA (RTM) PL5382 commercially available from BASF; polyurethane diols, such as those sold under the tradename K Flex (RTM), for example K Flex UD 320 commercially available from King Industries; aliphatic diols, such as those sold under the tradename K POL (RTM), for example K POL 8211 commercially available from King Industries; polyols such as those sold under the tradename Cardolite (RTM), for example Cardolite NX-9001, 9007 and 9014 commercially available from Cardolite; thermoplastic methacrylate polymers, such as those sold under the tradename Degalan (RTM), for example Degalan LP 6511 and 6512 commercially available from ROHM; poly vinyl butyrals, such as those sold under the tradename Mowital (RTM), for example Mowital B14S, B16H, BA 20S, B 60HH and B30T commercially available from Kuraray; poly tetrahydrofuran (THF) elastomers (such as those available from BASF); polyesters such as those sold under the tradename Dynapol 9RTM), for example Dynapol LS 615 and Dynapol LS 415 commercially available from Evonik, those sold under the tradename Vitel (RTM), for example Vitel 3200 commercially available from Bostik and those sold under the tradename Uralac (RTM), for example Uralac CP4197, SH994, SN908 and SH 979 commercially available from DSM; and combinations thereof. The plasticizer, when present, may be used in the coating composition in amounts from 0.01 to 20 wt %, such as from 0.01 to 15 wt %, such as from 0.01 to 10 w %, such as from 0.01 to 5 wt %, or even from 0.02 to 2 wt % based on the total weight of the coating composition.

The coating composition may be substantially free, may be essentially free or may be completely free of bisphenol A (BPA) and derivatives thereof. Derivatives of bisphenol A include, for example, bisphenol A diglycidyl ether (BADGE). The coating composition may also be substantially free, may be essentially free or may be completely free of bisphenol F (BPF) and derivatives thereof. Derivatives of bisphenol F include, for example, bisphenol F diglycidyl ether (BPFG). The compounds or derivatives thereof mentioned above may not be added to the coating composition intentionally but may be present in trace amounts because of unavoidable contamination from the environment. “Substantially free” refers to coating compositions, or components thereof, containing less than 1000 parts per million (ppm) of any of the compounds or derivatives thereof mentioned above. “Essentially free” refers to coating compositions, or components thereof, containing less than 100 ppm of any of the compounds or derivatives thereof mentioned above. “Completely free” refers to coating compositions, or components thereof, containing less than 20 parts per billion (ppb) of any of the compounds or derivatives thereof mentioned above.

The coating composition may be substantially free, may be essentially free or may be completely free of dialkyltin compounds, including oxides or other derivatives thereof. Suitable examples of dialkyltin compounds include, but are not limited to, dibutyltindilaurate (DBTDL); dioctyltindilaurate; dimethyltin oxide; diethyltin oxide; dipropyltin oxide; dibutyltin oxide (DBTO); dioctyltinoxide (DOTO) or combinations thereof. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating composition may be substantially free, may be essentially free or may be completely free of 2-ethyl hexanoate and/or 2-ethylhexanoic acid. By “substantially free” we mean to refer to coating compositions containing less than 1000 parts per million (ppm) of 2-ethyl hexanoate and/or 2-ethylhexanoic acid. By “essentially free” we mean to refer to coating compositions containing less than 100 ppm of 2-ethyl hexanoate and/or 2-ethylhexanoic acid. By “completely free” we mean to refer to coating compositions containing less than 20 parts per billion (ppb) of 2-ethyl hexanoate and/or 2-ethylhexanoic acid. The coating composition may comprise 0 wt % of 2-ethyl hexanoate and/or 2-ethylhexanoic acid. When a coating composition is substantially free, essentially free or completely free of 2-ethyl hexanoate and/or 2-ethylhexanoic acid, it will be appreciated that the method of forming the acrylic material, and/or any other material in said coating composition, typically does not comprise the use of 2-ethyl hexanoate and/or 2-ethylhexanoic acid as a catalyst (or otherwise).

The coating composition may be substantially free, may be essentially free or may be completely free of neodecanoate and/or neodecanoic acid. By “substantially free” we mean to refer to coating compositions containing less than 1000 parts per million (ppm) of neodecanoate and/or neodecanoic acid. By “essentially free” we mean to refer to coating compositions containing less than 100 ppm of neodecanoate and/or neodecanoic acid. By “completely free” we mean to refer to coating compositions containing less than 20 parts per billion (ppb) of neodecanoate and/or neodecanoic acid. The coating composition may comprise 0 wt % of neodecanoate and/or neodecanoic acid. When a coating composition is substantially free, essentially free or completely free of neodecanoate and/or neodecanoic acid, it will be appreciated that the method of forming the acrylic material, and/or any other material in said coating composition, typically does not comprise the use of neodecanoate and/or neodecanoic acid as a catalyst (or otherwise).

The coating composition may be substantially free, may be essentially free or may be completely free of formaldehyde. By “substantially free” we mean to refer to coating compositions containing less than 1000 parts per million (ppm) of formaldehyde. By “essentially free” we mean to refer to coating compositions containing less than 100 ppm of formaldehyde. By “completely free” we mean to refer to coating compositions containing less than 20 parts per billion (ppb) of formaldehyde. The coating composition may comprise 0 wt % of formaldehyde.

The coating composition may be substantially free, may be essentially free or may be completely free of styrene. By “substantially free” we mean to refer to coating compositions containing less than 1000 parts per million (ppm) of styrene. By “essentially free” we mean to refer to coating compositions containing less than 100 ppm of any of styrene. By “completely free” we mean to refer to coating compositions containing less than 20 parts per billion (ppb) of styrene. The coating composition may comprise 0 wt % of styrene.

The coating composition of the present invention may be applied to the substrate, or a portion thereof, as a single layer or as part of a multi layer system. The coating composition may be applied as a single layer. The coating composition may be applied to an uncoated substrate. For the avoidance of doubt, an uncoated substrate extends to a surface that is cleaned prior to application. The coating composition may be applied on top of another paint layer as part of a multi layer system. For example, the coating composition may be applied on top of a primer. The coating may form an undercoat layer or an overcoat layer. The coating composition may form an intermediate layer or a top coat layer. The coating composition may be applied as the first coat of a multi coat system. The second, third, fourth etc. coats may comprise any suitable paint such as those containing, for example, epoxy resins; polyester resins; polyurethane resins; polysiloxane resins; hydrocarbon resins or combinations thereof. The second, third, fourth etc. coats may be a liquid coating or a powder coating.

The coating composition may be applied as the first coat of a multi coat system. Thus, the coating composition may form an undercoat layer having an overcoat layer thereon. The overcoat layer may comprise a powder and/or liquid coating composition. The overcoat layer may comprise a liquid coating composition, such as a liquid coating comprising a polyester material. The overcoat layer may comprise a powder coating composition, such as a powder coating comprising a polyester material. The overcoat layer may be substantially free, may be essentially free or may be completely free of bisphenol A (BPA) and derivatives thereof and/or bisphenol F (BPF) and derivatives thereof, such as bisphenol A (BPA) and derivatives thereof and bisphenol F (BPF) and derivatives thereof. Definitions for “substantially free”, “essentially free” or “completely free” of bisphenol A (BPA) and derivatives thereof and bisphenol F (BPF) in relation to the overcoat layer are as defined herein in relation to the coating compositions of the present invention.

“Powder”, and like terms as used herein, refers to materials that are in the form of solid particulates, as opposed to materials which are in the liquid form.

Thus, there is also provided a package coated on at least a portion thereof with a coating system comprising an undercoat coating and an overcoat coating, the undercoat coating being derived from a solvent-borne undercoat coating composition, the solvent-borne undercoat coating composition comprising:
a) an acrylic material having one or more terminal and/or side group(s) of Formula (I)

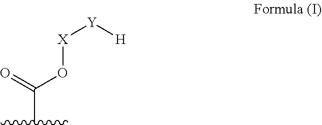

wherein X represents an organic bridging group comprising at least 5 (five) carbon atoms; and Y represents an oxygen (O), nitrogen (N) or sulphur(S) atom;
b) a crosslinker material operable to crosslink the hydroxyl functionality on the acrylic material; and
c) a carrier comprising a solvent; and the overcoat coating being derived from an overcoat coating composition, the overcoat coating composition comprising a polyester material, wherein overcoat coating composition is substantially free of bisphenol A (BPA) and derivatives thereof and bisphenol F (BPF) and derivatives thereof.

The overcoat coating composition may be a powder coating composition and/or a liquid coating composition, such as a powder coating composition.

The coating composition may be applied to the substrate once or multiple times.

The coating composition is applied to a package.

The package may be a metal package. Examples of metal packages include, but are not limited to, food and/or beverage packaging, components used to fabricate such packaging or monobloc aerosol cans and/or tubes. The food and/or beverage packaging may be a can. Examples of suitable cans include, but are not limited to, two-piece cans, three-piece cans and the like. Suitable examples of monobloc aerosol cans and/or tubes include, but are not limited to, deodorant and hair spray containers. Monobloc aerosol cans and/or tubes may be aluminium monobloc aerosol cans and/or tubes.

The coating composition may be applied to food and/or beverage packaging and/or monobloc aerosol cans and/or tubes or components used to fabricate such packaging.

The application of various pre-treatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This can be true when the contents of the can are acidic in nature. The coatings applied to the interior of metal cans also help prevent corrosion in the headspace of the cans, which is the area between the fill line of the product and the can lid; corrosion in the headspace can be problematic with food products having a high salt content. Coatings can also be applied to the exterior of metal cans. Certain coating compositions of the present invention may be applicable for use with coiled metal stock, such as the coiled metal stock from which the ends of cans are made (“can end stock”), and end caps and closures are made (“cap/closure stock”). Since coatings designed for use on can end stock and cap/closure stock may be applied prior to the piece being cut and stamped out of the coiled metal stock, they may be flexible and extensible. For example, such stock may be coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy open” can ends. For easy open can ends, a score substantially around the perimeter of the lid allows for easy opening or removing of the lid from the can, such as by means of a pull tab. For caps and closures, the cap/closure stock may be coated, such as by roll coating, and the cap or closure stamped out of the stock; it is possible, however, to coat the cap/closure after formation. Coatings for cans subjected to relatively stringent temperature and/or pressure requirements should also be resistant to popping, corrosion, blushing and/or blistering.

In more detail, a “package” is anything used to contain another item, such as for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which may range from several months to years. Thus, the present “package” is distinguished from a storage container or bakeware in which a consumer might make and/or store food; such a container would only maintain the freshness or integrity of the food item for a relatively short period. A package according to the present invention can be made of metal or non-metal, for example, plastic or laminate, and be in any form. An example of a suitable package is a laminate tube. Another example of a suitable package is metal can. The term “metal can” includes any type of metal can, container or any type of receptacle or portion thereof that is sealed by the food and/or beverage manufacturer to minimize or eliminate spoilage of the contents until such package is opened by the consumer. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which may be stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The package may be a food or beverage preparation capsule, for example, a capsule for the preparation of beverages such as coffee or coffee type beverages, tea, chocolate, milk (for infants or otherwise), broth, cider etc. In use, such a capsule is placed into a compatible machine whereupon water, which may be hot and/or pressurised, is contacted with the beverage ingredient by passing through the capsule to thereby cause beverage preparation by, for example dissolving, extracting, brewing or other interaction.

The packaging may be a general line product, such as drums, paint cans and/or pails, for example. The packaging may be a specialty product, such as a metal container, or even a hinged metal container (for confectionary, lighter fluid, tobacco etc.), for example, an Altoid container. The packaging may be an aluminium foil container, for example.

The coating composition can be applied to the interior and/or the exterior of the package.

The coating composition can be applied to the “side stripe” of a metal can, which will be understood as the seam formed during fabrication of a three-piece can. The coating composition could also be applied as a rim coat to the bottom of the can. The rim coat functions to reduce friction for improved handling during the continued fabrication and/or processing of the can. The coating composition can also be applied to caps and/or closures; such application can include, for example, a protective varnish that is applied before and/or after formation of the cap/closure and/or a pigmented enamel post applied to the cap, such as those having a scored seam at the bottom of the cap. Decorated can stock can also be partially coated externally with the coating described herein, and the decorated, coated can stock used to form various metal cans.

The coating composition may be a post repair coating composition, such as a post repair spray coating composition. Such coating compositions are specifically designed to be applied to and thereby coat a score line of the package. During the scoring operation, which is often achieved by stamping with a punch, the external varnish layer is cut and therefore the corrosion resistance of the metal substrate is compromised. This can be particularly problematic in a context where:
i) the metal has been stressed and therefore its resistance to corrosion is weakened
ii) the tin layer of the tinplate (where this is the substrate) is also cut; and/or
iii) the next treatment step of the packaging is sterilisation, where the presence of heat and high humidity will create high corrosion conditions
iv) The container is at the beginning of its life cycle which has a minimum of two years.

The corrosion resistance of the metal substrate is restored by the application of a post repair coating (derived from a post repair coating composition) to the score line. This coating is often applied by spraying, such as by an airless spray process.

The coating composition may be a single component coating composition (often referred to as a 1K coating composition) or a multiple component coating composition, such as a two-component coating composition (often referred to as a 2K coating composition). Such terminology is well known in the art. In a multiple component coating composition, the components are provided separately but introduced to each other (by mixing, for example) prior to application. This could be hours before application, for example up to 24 hours before application, or up to 12 hours before application or up to 8 hours before application or up to 4 hours before application. In some instances, the multiple components may be introduced to each other (such as by mixing) during the application process, such as in line mixing, for example. If the coating composition is a multiple component coating composition, such as a 2-component coating composition, the acrylic material may be provided in a first component, while other materials may be provided in a further component, (such as a second component). For example, the crosslinker material may be provided in a further component (such as a second component).

Metal coils, having wide application in many industries, are also substrates that can be coated according to the present invention. Coil coatings may comprise a colorant.

The coating composition is applied to at least a portion of the package. For example, when the coating compositions are applied to a food and/or beverage can and/or monobloc aerosol can and/or tube, the coating compositions may be applied to at least a portion of an internal and/or external surface of said food and/or beverage can and/or monobloc aerosol can and/or tube. For example, when the coating composition is applied to a food and/or beverage can, the coating composition may be applied to at least a portion of an internal surface of said food and/or beverage can.

The package may be formed from any suitable material. Suitable materials will be known to a person skilled in the art. Examples of suitable materials include, but are not limited to, steel; tinplate; tinplate pre-treated with a protective material such as chromium, titanium, titanate or aluminium; tin-free steel (TFS); galvanised steel, such as for example electro-galvanised steel; aluminium; aluminium alloy; and combinations thereof. The package may be formed from steel, tinplate, tin-plate pre-treated with a protective material such as chromium, titanium, titanate or aluminium, tin-free steel (TFS), galvanised steel, such as for example electro-galvanised steel or combinations thereof.

The package may be formed from a chromium-free material. As used herein “chromium free” refers to a material that may or may not have undergone a pre-treatment process. Where the material has undergone a pre-treatment process involving passivation, the passivation solutions used are substantially free, may be essentially free or may be completely free of chromium compounds such as, for example, disodium chromate. By “substantially free” we mean to refer to passivation solutions containing less than 1000 parts per million (ppm) of chromium compounds such as, for example, disodium chromate. By “essentially free” we mean to refer to passivation solutions containing less than 100 ppm of chromium compounds such as, for example, disodium chromate. By “completely free” we mean to refer to passivation solutions containing less than 20 parts per billion (ppb) of chromium compounds such as, for example, disodium chromate. The passivation process may not comprise chromium compounds, such as hexavalent chromium compounds. For example, the passivation process may not comprise contacting or immersing a material with and/or in a solution comprising chromium compounds such as hexavalent chromium compounds.

The passivation process may comprise a passivation 505 or 555 method, such as a 505 or 555 passivation method from Arcelor, TATA or US Steel, and/or a passivation method based on Henkel Granodine 1456. The chromium-free material may be obtained from a commercial source.

The coating composition may be applied to the substrate (package) by any suitable method. Methods of applying the coating composition will be known to a person skilled in the art. Suitable application methods include, but are not limited to, electrocoating such as electrodeposition; spraying; electrostatic spraying; dipping; rolling; brushing; and the like. The coating composition may be applied to the substrate by spraying and/or rolling. For example, the coating composition may be applied by rolling to a flat sheet prior to the substrate (flat sheet) being formed into a can, such as a three-piece can, for example. The coating composition may be a spray composition. For the avoidance of doubt, by the term ‘spray composition’ and like terms as used herein is meant, unless specified otherwise, that the coating composition is suitable to be applied to a substrate by spraying, i.e. is sprayable. The coating composition may be applied to a metal substrate by lamination. For example, a film may be formed from the coating composition, which film may subsequently be applied to a metal substrate (package, for example a food or beverage can) by lamination thereon.

The coating composition may be applied to any suitable dry film thickness. The coating composition may be applied to a dry film thickness from 0.5 to 100 microns (μm), suitably from 0.5 to 75 μm, such as from 1 to 50 μm, or even from 1 to 40 μm.

The term “alk” or “alkyl”, as used herein unless otherwise defined, relates to saturated hydrocarbon radicals being straight, branched, cyclic or polycyclic moieties or combinations thereof and contain 1 to 20 carbon atoms, such as 1 to 10 carbon atoms, such as 1 to 8 carbon atoms, such as 1 to 6 carbon atoms, or even 1 to 4 carbon atoms. These radicals may be optionally substituted with a chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, aryl or Het, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from methyl, ethyl, n-propyl, isopropyl, n-butyl, isobutyl, sec-butyl, tert-butyl, 2-methylbutyl, pentyl, iso-amyl, hexyl, cyclohexyl, 3-methylpentyl, octyl and the like. The term “alkylene”, as used herein, relates to a bivalent radical alkyl group as defined above. For example, an alkyl group such as methyl which would be represented as —CH₃, becomes methylene, —CH₂—, when represented as an alkylene. Other alkylene groups should be understood accordingly.

The term “alkenyl”, as used herein, relates to hydrocarbon radicals having, such as up to 4, double bonds, being straight, branched, cyclic or polycyclic moieties or combinations thereof and containing from 2 to 18 carbon atoms, such as 2 to 10 carbon atoms, such as from 2 to 8 carbon atoms, such as 2 to 6 carbon atoms, or even 2 to 4 carbon atoms. These radicals may be optionally substituted with a hydroxyl, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from alkenyl groups include vinyl, allyl, isopropenyl, pentenyl, hexenyl, heptenyl, cyclopropenyl, cyclobutenyl, cyclopentenyl, cyclohexenyl, 1-propenyl, 2-butenyl, 2-methyl-2-butenyl, isoprenyl, farnesyl, geranyl, geranylgeranyl and the like. The term “alkenylene”, as used herein, relates to a bivalent radical alkenyl group as defined above. For example, an alkenyl group such as ethenyl which would be represented as —CH═CH₂, becomes ethenylene, —CH═CH—, when represented as an alkenylene. Other alkenylene groups should be understood accordingly.

The term “alkynyl”, as used herein, relates to hydrocarbon radicals having, such as up to 4, triple bonds, being straight, branched, cyclic or polycyclic moieties or combinations thereof and having from 2 to 18 carbon atoms, such as 2 to 10 carbon atoms, such as from 2 to 8 carbon atoms, such as from 2 to 6 carbon atoms, or even from 2 to 4 carbon atoms. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or lower alkyl, and/or be interrupted by oxygen or sulphur atoms, or by silano or dialkylsiloxane groups. Examples of such radicals may be independently selected from alkynyl radicals include ethynyl, propynyl, propargyl, butynyl, pentynyl, hexynyl and the like. The term “alkynylene”, as used herein, relates to a bivalent radical alkynyl group as defined above. For example, an alkynyl group such as ethynyl which would be represented as —C≡CH, becomes ethynylene, —C≡C—, when represented as an alkynylene. Other alkynylene groups should be understood accordingly.

The term “aryl” as used herein, relates to an organic radical derived from an aromatic hydrocarbon by removal of one hydrogen, and includes any monocyclic, bicyclic or polycyclic carbon ring of up to 7 members in each ring, wherein a ring is aromatic. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or lower alkyl, and/or be interrupted by oxygen or sulphur atoms, or by silano or dialkylsilcon groups. Examples of such radicals may be independently selected from phenyl, p-tolyl, 4-methoxyphenyl, 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-4-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl, tetrahydronaphthyl, indanyl, biphenyl, phenanthryl, anthryl or acenaphthyl and the like. The term “arylene”, as used herein, relates to a bivalent radical aryl group as defined above. For example, an aryl group such as phenyl which would be represented as -Ph, becomes phenylene, -Ph-, when represented as an arylene. Other arylene groups should be understood accordingly.

For the avoidance of doubt, the reference to alkyl, alkenyl, alkynyl, aryl or aralkyl in composite groups herein should be interpreted accordingly, for example the reference to alkyl in aminoalkyl or alk in alkoxyl should be interpreted as alk or alkyl above etc.

As used herein, unless otherwise expressly specified, all numbers such as those expressing values, ranges, amounts or percentages may be read as if prefaced by the word “about”, even if the term does not expressly appear. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

Singular encompasses plural and vice versa. For example, although reference is made herein to “a” crosslinker material, “a” solvent, “an” acrylic material, and the like, one or more of each of these and any other components can be used. As used herein, the term “polymer” refers to oligomers and both homopolymers and copolymers, and the prefix “poly” refers to two or more. Including, for example and like terms means including for example but not limited to.

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present invention has been described in terms of “comprising”, the coating compositions detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

The present invention may also be according to the following aspects:

1. A package coated on at least a portion thereof with a coating, the coating being derived from a coating composition, the coating composition comprising:
a) an acrylic material having one or more terminal and/or side group(s) of Formula (I)

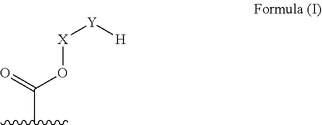

wherein X represents an organic bridging group comprising at least 5 (five) carbon atoms; and Y represents an oxygen (O), nitrogen (N) or sulphur(S) atom; and
b) a crosslinker material operable to crosslink the hydroxyl, amine and/or thiol functionality on the acrylic material.

2. A package coated on at least a portion thereof with a coating system comprising (i) an undercoat coating and (ii) an overcoat coating:
the undercoat coating (i) being derived from an undercoat coating composition, the undercoat coating composition comprising:
   a) an acrylic material having one or more terminal and/or side group(s) of Formula (I)

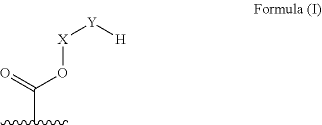

wherein X represents an organic bridging group comprising at least 5 (five) carbon atoms; and Y represents an oxygen (O), nitrogen (N) or sulphur(S) atom; and
b) a crosslinker material operable to crosslink the hydroxyl, amine and/or thiol functionality on the acrylic material; and
   and the overcoat coating (ii) being derived from an overcoat coating composition, the overcoat coating composition comprising a polyester material, wherein overcoat coating composition is substantially free of bisphenol A (BPA) and derivatives thereof and bisphenol F (BPF) and derivatives thereof.

3. A package according to any one of aspects 1 or 2, wherein the coating composition of aspect 1 and the undercoat composition of aspect 2 is a water-borne coating composition and further comprises a carrier comprising water.

4. A package according to any one of aspects 1 or 2, wherein the coating composition of aspect 1 and the undercoat composition of aspect 2 is a powder coating composition.

5. A package according to any one of aspects 1 to 4, wherein Y is an oxygen (O) and/or nitrogen (N) atom.

6. A package according to aspect 5, wherein Y is an oxygen (O) atom.

7. A package according to any one of aspects 1 to 5, wherein the bridging group, X, comprises at least 14 (fourteen) carbon atoms.

8. A package according to any one of aspects 1 to 7, wherein the terminal and/or side group(s) of Formula (I) are derived from the reaction between a hydroxyl, carboxylic acid, oxirane, amine and/or thiol group and a cyclic ester, hydroxy acid, ester of a hydroxy acid and/or cyclic amide, such as between a hydroxyl and/or carboxylic acid group and a cyclic ester and/or cyclic amide, such as between a hydroxyl group and/or carboxylic acid group and a cyclic ester, or even between a hydroxyl group and a cyclic ester.

9. A package according to aspect 8, wherein the cyclic ester comprises a lactone and/or lactide.

10. A package according to aspect 9, wherein the lactone and/or lactide comprises caprolactone.

11. A package according to aspect 8, wherein the cyclic amide comprises a lactam.

12. A package according to any one of aspects 9 or 10, wherein the terminal and/or side group(s) comprise an average of at least 1.5 (n≥1.5) continuous lactone and/or lactide units in a poly(lactone) and/or poly(lactide) chain.

13. A package according to any one of aspects 1 to 12, wherein the bridging group, X, comprises at least one carbonyl group.

14. A package according to any one of aspects 1 to 13, wherein the acrylic material has a hydroxyl value (OHV) of at least 10 mg KOH/g.

15. A package according to any one of aspects 1 to 14, wherein the acrylic material comprises a di(alk)acrylate and/or tri(alk)acrylate.

16. A package according to any one of aspects 1 to 15, wherein the acrylic material is substantially free of styrene.

17. A package according to any one of aspects 1 to 16, wherein the crosslinking material comprises a phenolic resin.

18. A package according to aspect 17, wherein the crosslinking material further comprises an isocyanate resin and/or benzoguanamine and/or derivatives thereof.

19. A package according to any one of aspects 1 to 18, wherein the coating composition has a flexibility of at least 60% as measured according to the wedge bend test as described in paragraph of the description.

20. A package according to any one of aspects 1 to 19, wherein the package is a metal package.

21. A package according to aspect 20, wherein the metal package is a food and/or beverage package and/or a monobloc aerosol can and/or tube.

22. A package according to any one of aspects 1 to 21, wherein the acrylic material is formed by a method comprising reacting an acrylic pre-polymer having one or more hydroxyl, carboxylic acid, oxirane, amine and/or thiol group(s) with a cyclic ester, hydroxy acid, ester of a hydroxy acid and/or cyclic amide.

23. A package according to any one of aspects 5 to 22, wherein the acrylic material is formed by a method comprising the steps of:
a) preparing an acrylic pre-polymer having one or more hydroxyl, carboxylic acid, oxirane, amine and/or thiol functional group(s) by atom transfer radical polymerisation (ATRP); and
b) reacting said hydroxyl, carboxylic acid, oxirane, amine and/or thiol group(s) of the acrylic pre-polymer with a cyclic ester, hydroxy acid, ester of a hydroxy acid and/or cyclic amide.

24. A package according to any one of aspects 1 to 23, wherein the coating composition is applied to at least a portion of the packaging and cured at a temperature of at least 140° C. to form the coating.

25. A package coated on at least a portion thereof with a coating, the coating being derived from a coating composition, the coating composition comprising:
a) an acrylic material having one or more terminal and/or side group(s) of Formula (Ia)

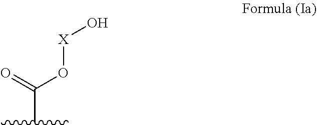

wherein X represents an organic bridging group comprising at least 5 (five) carbon atoms; and
b) a crosslinker material operable to crosslink the hydroxyl functionality on the acrylic material,
   wherein the terminal and/or side group(s) of Formula (Ia) is derived from the reaction between a hydroxyl, carboxylic acid, amine and/or thiol group and a lactone and/or lactide; and wherein the terminal and/or side group(s) comprise an average of at least 1.5 (n≥1.5) continuous lactone and/or lactide units in a poly(lactone) and/or poly(lactide) chain.

26. A package coated on at least a portion thereof with a coating system comprising (i) an undercoat coating and (ii) an overcoat coating:
the undercoat coating (i) being derived from an undercoat coating composition, the undercoat coating composition comprising:
   a) an acrylic material having one or more terminal and/or side group(s) of Formula (I)

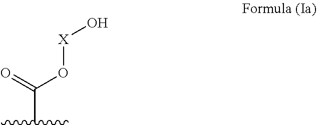

wherein X represents an organic bridging group comprising at least 5 (five) carbon atoms; and
b) a crosslinker material operable to crosslink the hydroxyl functionality on the acrylic material;
   wherein the terminal and/or side group(s) of Formula (I) is derived from the reaction between a hydroxyl, carboxylic acid, amine and/or thiol group and a lactone and/or lactide; and wherein the terminal and/or side group(s) comprise an average of at least 1.5 (n≥1.5) continuous lactone and/or lactide units in a poly(lactone) and/or poly(lactide) chain;
   and the overcoat coating (ii) being derived from an overcoat coating composition, the overcoat coating composition comprising a polyester material, wherein overcoat coating composition is substantially free of bisphenol A (BPA) and derivatives thereof and bisphenol F (BPF) and derivatives thereof.

27. A package according to any one of aspects 25 or 26, wherein the coating composition of aspect 25 and the undercoat composition of aspect 26 is a water-borne coating composition and comprises a carrier comprising water.

28. A package according to any one of aspects 26 or 26, wherein the coating composition of aspect 25 and the undercoat composition of aspect 26 is a powder coating composition.

29. A package according to any one of aspects 25 to 28, wherein the bridging group, X, comprises at least 12 (twelve) carbon atoms, such as at least 14 (fourteen) carbon atoms.

30. A package according to any one of aspects 25 to 29, wherein the lactone and/or lactide comprises caprolactone.

31. A package according to any one of aspects 25 to 30, wherein the hydroxyl, carboxylic acid, amine and/or thiol groups comprise an average of at least 1.5 (n≥1.5) of said lactone and/or lactide.

32. A package according to any one of aspects 25 to 31, wherein the bridging group, X, comprises at least one carbonyl group.

33. A package according to any one of aspects 25 to 32, wherein the acrylic material has a hydroxyl value (OHV) of at least 10 mg KOH/g.

34. A package according to any one of aspects 25 to 33, wherein the acrylic material comprises a di(alk)acrylate and/or tri(alk)acrylate.

35. A package according to any one of aspects 25 to 34, wherein the acrylic material is substantially free of styrene.

36. A package according to any one of aspects 25 to 35, wherein the crosslinking material comprises a phenolic resin.

37. A package according to aspect 36, wherein the crosslinking material further comprises an isocyanate resin and/or benzoguanamine and/or derivatives thereof.

38. A package according to any one of aspects 25 to 37, wherein the coating composition has a flexibility of at least 60% as measured according to the wedge bend test as described in paragraph of the description.

39. A package according to any one of aspects 25 to 38, wherein the package is a metal package.

40. A package according to aspect 39, wherein the metal package is a food and/or beverage package and/or a monobloc aerosol can and/or tube.

41. A package according to any one of aspects 25 to 40, wherein the acrylic material is formed by a method comprising reacting an acrylic pre-polymer having one or more hydroxyl, carboxylic acid, amine and/or thiol group(s) with a lactone and/or lactide.

42. A package according to any one of claims 25 to 41, wherein the acrylic material is formed by a method comprising the steps of:
a) preparing an acrylic pre-polymer having one or more hydroxyl, carboxylic acid, amine and/or thiol functional group(s) by atom transfer radical polymerisation (ATRP); and
b) reacting said hydroxyl, carboxylic acid, amine and/or thiol group(s) of the acrylic pre-polymer with a lactone and/or lactide.

43. A package according to any one of aspects 25 to 42, wherein the coating composition is applied to at least a portion of the packaging and cured at a temperature of at least 140° C. to form the coating.

All of the features contained herein may be combined with any of the above aspects in any combination.

For a better understanding of the invention, and to show how embodiments of the same may be carried into effect, reference will now be made, by way of example, to the following examples.

### EXAMPLES

### Acrylic Material Example 1

Acrylic material example 1 was prepared according to the formulation in Table 1 and by the following method. All amounts are given in parts by weight unless otherwise specified.

Components 1 and 2 were added to a 2 litre, 4 necked flask equipped with a motor driven stainless stir blade, water-cooled condenser and a heating mantle with a thermometer connected through a temperature feedback control device. The contents of the flask were heated to 125° C. under a nitrogen blanket. Components 3 and 4 were pre-mixed and added into the flask through an addition funnel over 180 minutes. 10 minutes after the addition of components 3 and 4 was started, components 5-8 were pre-mixed and added into the flask through a separate addition funnel over 150 minutes. After the addition of components 5-8 was complete, the addition funnel was rinsed with component 9. After the addition of components 3 and 4 was complete, the reaction was held at 125° C. for 1 hour. Components 10 and 11 were then added over 15 minutes. After this time, the funnel was rinsed with component 12 and the reaction was held at 125° C. for another 1 hour. Components 13 and 14 were then added to the reaction. The reaction mixture was then cooled to below 40° C. and poured out into a collection container.

The resultant acrylic material had a hydroxyl value (OHV) of 48.9 mg KOH/g and an Mn of 5,693 Da.

TABLE 1
Formulation of acrylic material example1
Acrylic Material Example 1

| | Component | Amount/pbw |
|---|---|---|
| 1 | Dowanol PM Acetate | 100 |
| 2 | Solvesso A-150 | 100 |
| 3 | Luperox 575 ¹ | 15 |
| 4 | Dowanol PM Acetate | 80 |
| 5 | Styrene | 150 |
| 6 | Tone M-100 ² | 150 |
| 7 | 2-ethylhexyl methacrylate | 84.75 |
| 8 | Methyl methacrylate | 115.25 |
| 9 | Solvesso A-150 | 10 |
| 10 | Luperox 575 ² | 5 |
| 11 | Solvesso A-150 | 20 |
| 12 | Solvesso A-150 | 10 |
| 13 | Dowanol PM Acetate | 70 |
| 14 | Solvesso A-150 | 110 |

¹ commercially available from Arkema. Inc
² commercially available from Dow Chemical

### Comparative Acrylic Material Example 1

Comparative acrylic material example 1 was prepared according to the formulation in Table 2 and by the following method. All amounts are given in parts by weight unless otherwise specified.

Component 1 was added to a 2 liter, 4 necked flask equipped with a motor driven stainless stir blade, water-cooled condenser and a heating mantle with a thermometer connected through a temperature feedback control device. The contents of the flask were heated to 125° C. under a nitrogen blanket. Components 2 and 3 were pre-mixed and added into the flask through an addition funnel over 180 minutes. 10 minutes after the addition of components 2 and 3 was started, components 4-7 were pre-mixed and added into the flask through a separate addition funnel over 150 minutes. After the addition of components 4-7 was complete, the funnel was rinsed with component 8. After the addition of components 2 and 3 was complete, the reaction was held at 125° C. for 1 hour. Components 9 and 10 were then added over 15 minutes. The funnel was then rinsed with component 11 and the reaction was held at 125° C. for another 1 hour. After this time, component 12 was added to the reaction. The reaction mixture was then cooled to below 40° C. and poured out into a collection container.

The resultant comparative acrylic material had a hydroxyl value (OHV) of 100 mg KOH/g and an Mn of 7,896 Da.

TABLE 2
Formulation of comparative acrylic material example1
Comparative Acrylic Material Example 1

| | Component | Amount/pbw |
|---|---|---|
| 1 | Dowanol PM Acetate | 200 |
| 2 | Tert-butyl peroxyacetate initiator ¹ | 10 |
| 3 | Dowanol PM Acetate | 80 |
| 4 | Styrene | 150 |
| 5 | 2-Hydroxyethyl acrylate | 103.5 |
| 6 | 2-Ethylhexyl methacrylate | 122.95 |
| 7 | Methyl methacrylate | 123.75 |
| 8 | Dowanol PM Acetate | 10 |
| 9 | Tert-butyl peroxyacetate initiator ¹ | 5 |
| 10 | Dowanol PM Acetate | 20 |
| 11 | Dowanol PM Acetate | 10 |
| 12 | Dowanol PM Acetate | 180 |

¹ 50% solution in mineral spirits, commercially available from Arkema Inc.

### Coating Composition 1

Coating composition 1 was prepared according to the formulation in Table 3. All amounts are given in parts by weight unless otherwise specified. All coating components were added into a vessel then mixed thoroughly by stirring. The final coating composition was 45 wt % solids.

### Comparative Coating Composition 1

Comparative coating composition 1 was prepared according to the formulation in Table 3. All amounts are given in parts by weight unless otherwise specified. All coating components were added into a vessel then mixed thoroughly by stirring. The final coating composition was 45 wt % solids.

TABLE 3
Formulation of coating composition 1
and comparative coating composition 1

| | | Coating | Comparative coating |
|---|---|---|---|
| | Component | composition 1 | composition 1 |
| 1 | Acrylic material 1 | 75.65 | |
| 2 | Comparative acrylic | | 75.68 |
| | material 1 | | |
| 3 | Phenolic crosslinker ¹ | 11.30 | 11.27 |
| 4 | Catalyst ² | 2.43 | 2.43 |
| 5 | Wax ³ | 1.51 | 1.51 |
| 6 | Xylene | 4.51 | 4.51 |
| 7 | Dowanol PMA Glycol Ether | 4.51 | 4.51 |
| | Acetate ⁴ | | |
| 8 | Additive ⁵ | 0.09 | 0.09 |

¹ Curaphen 40-852 commercially available from Bitrez
² Cycat XK 406N commercially available from Allnex
³ Lanolin LA 1678 (15% solution) commercially available from Croda
⁴ Dowanol PMA Glycol Ether Acetate commercially available from Dow Chemical
⁵ BORCHI GOL 1376 commercially available from Borchers

### Comparative Coating Composition 2

Comparative coating composition 2 is PPG 2092, a BPA-epoxy coating commercially available from PPG Industries.

The properties of the coatings were then tested by the following methods. The results are shown in Table 4.

Test panel preparation: Coated panels were prepared by drawing the coating compositions over electro tinplated (ETP) steel panels with a @12 wire-wound rod to achieve dry film weight of 8 to 9 g/m² (gsm). After application, the coated panels were baked to a continuous peak metal temperature of 200° C. for 10 min.

Wedge bend test: Flexibility of the coating compositions was evaluated using a wedge bend test. Coated panels were cut into 2 inch by 4 inch pieces, with the substrate grain running perpendicular to the long length of the cut panel. They were then bent over a ⅛ inch metal rod along the long length of the panel with the coated side facing out. The bent panels were then placed onto a block of metal with a pre-cut wedge having a taper of 0 to ⅛ inch along a 4 inch length. Once placed in the wedge, each bent panel was struck with a block of metal which weighed 4 pounds from a height of 12 inches using a BYK Garner impact tester (to form a wedge where one end of the coated panel impinged upon itself and a ⅛ inch space remained on the opposite end). Wedge bent panels were then placed into an aqueous solution of copper sulphate (15 wt %) and hydrochloric acid (7.5 wt %) for two minutes. The panels were then examined visually through a microscope at 10× power and the length of coating having a continuous fracture was measured. The percentage of coating having a continuous fracture was calculated as the length of continuously fractured area versus (over) the total length of the wedge bend (x %). The flexibility of the coating compositions were reported as (1-x) %.

MEK Double Rubs: a gauze covered hammer saturated with methyl ethyl ketone was rubbed over the coated panels. The coatings were evaluated for the number of double rubs it took to soften and break through the coating (to a maximum of 50 double rubs).

Salt Retort Test: The resistance of the coatings was tested according to the “Salt Retort” test Coated panels were immersed into the a 1 wt % sodium chloride salt solution and placed in a steam autoclave for 60 minutes at 130° C. and 15 psi. The panels were then cooled in deionized water, dried, and immediately rated for blush and adhesion as described below.

Blush: Coatings were evaluated for their ability to resist blushing and to adhere to the electro tinplated panels after the Salt Retort test as described above. Blush was rated visually using a scale of 0-5 where a rating of “0” indicates no blush and “5” indicates complete whitening of the film.

Cross-Hatch Adhesion Test: The adhesion of the coatings was determined according to ASTM D 3359 Test Method B, using Scotch 610 tape (available from 3M Company of Saint Paul, Minn). Adhesion was reported on a scale of 0-5, where a ratio of “0” indicates no adhesion loss while a rating of “5” indicates greater than 65% adhesion loss.

TABLE 4
Test Results

| | | Comparative | Comparative |
|---|---|---|---|
| | Coating | Coating | Coating |
| | Composition 1 | Composition 1 | Composition 2 |
| MEK Double Rubs | 30 | 33 | 50 |
| Flexibilty | 80% | 50% | 79% |
| Blush after | 0 | 0 | 0 |
| Salt Retort | | | |
| Cross-Hatch | 0 | 0 | 2 |
| Adhesion after | | | |
| Salt Retort | | | |

The results show that the coating according to the present invention perform, as well, or better, than the coatings of the comparative examples. In particular, the coating according to the present invention has improved flexibility compared to the coatings of the comparative examples.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A package coated on at least a portion thereof with a coating, the coating being derived from a solvent-borne coating composition, the solvent-borne coating composition comprising:
a) an acrylic material having one or more terminal and/or side group(s) of Formula (I) 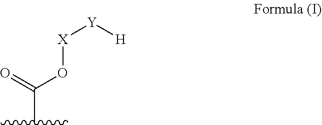
wherein X represent an organic bridging group comprising at least 5 (five) carbon atoms; and Y represents an oxygen (O), nitrogen (N) or sulphur(S) atom;
b) a crosslinker material operable to crosslink the hydroxyl, amine and/or thiol functionality on the acrylic material; and
c) a carrier comprising a solvent.

2. A package coated on at least a portion thereof with a coating system comprising (i) an undercoat coating and (ii) an overcoat coating;
the undercoat coating (i) being derived from a solvent-borne undercoat coating composition, the solvent-borne undercoat coating composition comprising:
a) an acrylic material having one or more terminal and/or side group(s) of Formula (I) 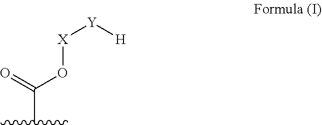
wherein X represents an organic bridging group comprising at least 5 (five) carbon atoms; and Y represents an oxygen (O), nitrogen (N) or sulphur(S) atom;
b) a crosslinker material operable to crosslink the hydroxyl, amine and/or thiol functionality on the acrylic material; and
c) a carrier comprising a solvent;
and the overcoat coating (ii) being derived from an overcoat coating composition, the overcoat coating composition comprising a polyester material, wherein overcoat coating composition is substantially free of bisphenol A (BPA) and derivatives thereof and bisphenol F (BPF) and derivatives thereof.

3. A package according to claim 1, wherein Y is an oxygen (O) and/or nitrogen (N) atom.

4. A package according to claim 3, wherein Y is an oxygen (O) atom.

5. A package according to claim 1, wherein the bridging group, X, comprises at least 6 (six) carbon atoms, such as at least 12 (twelve) carbons atoms, or even at least 14 (fourteen) carbon atoms.

6. A package according to claim 3, wherein the terminal and/or side group(s) of Formula (I) are derived from the reaction between a hydroxyl, carboxylic acid, oxirane, amine and/or thiol group and a cyclic ester, hydroxy acid, ester of a hydroxy acid and/or cyclic amide, such as between a hydroxyl and/or carboxylic acid group and a cyclic ester and/or cyclic amide, such as between a hydroxyl group and/or carboxylic acid group and a cyclic ester, or even between a hydroxyl group and a cyclic ester.

7. A package according to claim 6, wherein the cyclic ester comprises a lactone and/or lactide.

8. A package according to claim 7, wherein the lactone and/or lactide comprises caprolactone.

9. A package according to claim 6, wherein the cyclic amide comprises a lactam.

10. A package according to claim 7, wherein the terminal and/or side group(s) comprise an average of at least 1.5 (n≥1.5) continuous lactone and/or lactide units in a poly(lactone) and/or poly(lactide) chain.

11. A package according to claim 1, wherein the bridging group, X, comprises at least one carbonyl group.

12. A package according to claim 1, wherein the acrylic material has a hydroxyl value (OHV) of at least 10 mg KOH/g.

13. A package according to claim 1, wherein the acrylic material comprises a di(alk)acrylate and/or tri(alk)acrylate.

14. A package according to claim 1, wherein the acrylic material is substantially free of styrene.

15. A package according to claim 1, wherein the crosslinking material comprises a phenolic resin.

16. A package according to claim 15, wherein the crosslinking material further comprises an isocyanate resin and/or benzoguanamine and/or derivatives thereof.

17. A package according to claim 1, wherein the coating composition has a flexibility of at least 60% as measured according to the wedge bend test as described in paragraph of the description.

18. A package according to claim 1, wherein the package is a metal package.

19. A package according to claim 18, wherein the metal package is a food and/or beverage package and/or a monobloc aerosol can and/or tube.

20. A package according to claim 3, wherein the acrylic material is formed by a method comprising reacting an acrylic pre-polymer having one or more hydroxyl, carboxylic acid, oxirane, amine and/or thiol group(s) with a cyclic ester, hydroxy acid, ester of a hydroxy acid and/or cyclic amide.

21. (canceled)

22. (canceled)
